(19) United States
(12) Patent Application Publication
(10) Pub. No.: US 2026/0368064 A1
(43) Pub. Date: Nov. 19, 2026

(54) WRITING AND EXTENDING DIAGNOSTIC LOG FILES

(71) Applicant: International Business Machines Corporation, Armonk, NY (US)

(72) Inventors: Fu Fei Xu, Beijing (CN); SU LI HOU, Beijing (CN); Qian Tao, Beijing (CN); Yi Lei Wang, Beijing (CN); Jia Dong Yang, San He Shi (CN); Wen Jing Shi, Beijing (CN)

(21) Appl. No.: 19/206,104

(22) Filed: May 13, 2025

(51) Int. Cl. G06F 11/34; G06F 11/30; G06F 16/21

(52) U.S. Cl. CPC G06F 11/3476; G06F 11/3034; G06F 16/217

(57) ABSTRACT

Embodiments of the invention provide a computer-implemented method that includes detecting an event by electronically monitoring and capturing, using a processor system, operational data associated with operations performed by subcomponents within an electronic system, where the operations are separated from one another by sub-millisecond time gaps. Responsive to detecting the event, the processor system is used to generate an event record. Further responsive to detecting the event, the processor system is used to, based at least in part on a type of the event, generate context information associated with the event. The context information is stored in a memory location instead of inserting the context information into the event record. A shorthand technique is applied to one or more segments of the event record to generate a shorthand version of the event record. The shorthand version of the event record is written in an initial diagnostic log file.

### BACKGROUND

The present invention relates in general to the automated management and control of electronic systems. More specifically, the present invention relates to computing systems, computer-implemented methods, and computer program products configured to control the time and computer resources used to write and extend diagnostic log files for various events that occur in a monitored electronic system.

Diagnostic logging systems monitor and/or capture operational data associated with operations performed by components of a monitored electronic systems. Diagnostic logging system hardware and software include, for example, processors, memory modules, storage devices, network interfaces, and specialized logging algorithms. Monitored operational data is captured based on an association of the monitored operational data with “events” in the monitored electronic system. The events include, for example, user logins, system errors, security breaches, application failures, and other system operations that reflect system performance and/or stability. Captured operational data associated with multiple types of events (i.e., event data) can be processed and written (or recorded) as electronic records organized into diagnostic logs or diagnostic log files. Where the monitored electronic system is a database having a database management system (DBMS), diagnostic logging systems can be integrated into DBMS hardware/software to monitor, capture and write data associated with events that occur, for example, within a query processor, a transaction manager, and/or a storage element of the DBMS.

### SUMMARY

Embodiments of the invention provide a computer-implemented method that includes detecting an event by electronically monitoring and capturing, using a processor system, operational data associated with operations performed by subcomponents within an electronic system, where the operations are separated from one another by sub-millisecond time gaps. Responsive to detecting the event, the processor system is used to generate an event record. Further responsive to detecting the event, the processor system is used to, based at least in part on a type of the event, generate context information associated with the event. The context information is stored in a memory location instead of inserting the context information into the event record. A shorthand technique is applied to one or more segments of the event record to generate a shorthand version of the event record. The shorthand version of the event record is written in an initial diagnostic log file.

Embodiments of the invention are also directed to computer systems and computer program products having substantially the same features, technical effects, and technical benefits as the computer-implemented method described above.

Additional features and advantages are realized through techniques described herein. Other embodiments and aspects are described in detail herein. For a better understanding, refer to the description and to the drawings.

### BRIEF DESCRIPTION OF THE DRAWINGS

The subject matter which is regarded as embodiments is particularly pointed out and distinctly claimed in the claims at the conclusion of the specification. The foregoing and other features and advantages of the embodiments are apparent from the following detailed description taken in conjunction with the accompanying drawings in which:

FIG. 1 depicts an exemplary computing environment configured to implement embodiments of the invention;

FIG. 2 depicts a simplified block diagram illustrating a monitored electronic system and a diagnostic logging system configured to implement embodiments of the invention;

FIG. 3A depicts a non-limiting example of an initial diagnostic log file, function code, and memory-stored, extended context information in accordance with embodiments of the invention;

FIG. 3B depicts a non-limiting example of an interpreted diagnostic log file in accordance with embodiments of the invention;

FIG. 3C depicts a non-limiting example of a log event payload, associated non-extended context information, and associated extended context information that can be utilized to implement embodiments of the invention;

FIG. 4 depicts a simplified block diagram illustrating a non-limiting example of system components and a computer-implemented method for generating an initial diagnostic log file, function code, and extended context information stored in a memory location in accordance with embodiments of the invention;

FIG. 5 depicts a simplified block diagram illustrating a non-limiting example of system components and a computer-implemented process flow in accordance with embodiments of the invention;

FIG. 6 depicts a simplified block diagram illustrating a non-limiting example of a DBMS having a diagnostic logging system configured to implement embodiments of the invention;

FIG. 7A depicts a process flow illustrating a computer-implemented method in accordance with embodiments of the invention;

FIG. 7B depicts a process flow illustrating a computer-implemented method in accordance with embodiments of the invention;

FIG. 8 depicts a simplified block diagram illustrating additional details of selected portions of the DBMS and diagnostic logging system shown in FIG. 6;

FIG. 9 depicts a simplified block diagram illustrating additional details of selected portions of the DBMS and diagnostic logging system shown in FIG. 6;

FIG. 10 depicts a simplified block diagram illustrating additional details of selected portions of the DBMS and diagnostic logging system shown in FIG. 6;

FIG. 11 depicts a simplified block diagram illustrating additional details of selected portions of the DBMS and diagnostic logging system shown in FIG. 6; and

FIG. 12 depicts a flow diagram illustrating a non-limiting example of an algorithm that can be utilized in embodiments of the invention.

In the accompanying figures and following detailed description of the disclosed embodiments, some of the elements illustrated in the figures are provided with reference numbers. In some instances, the leftmost digit of each reference number corresponds to the figure in which its element is first illustrated.

### DETAILED DESCRIPTION

Turning now to an overview of technologies that are relevant to and support aspects of the invention, diagnostic logging systems utilize computer hardware and software to automatically monitor, capture, and/or process (e.g., interpret) detailed operational data generated by various types operations performed by various types of electronic systems. Operational data is the precise, real-time technical data/information generated by the electronic system, including metrics such as CPU utilization, memory consumption, disk I/O statistics, network throughput, transaction logs, and the like, all of which are monitored continuously by the diagnostic logging system. Monitored operational data is captured based on a determination that the monitored operational data is associated with or represents an event within the monitored electronic system. Diagnostic logging systems detect a wide array of event types and event-related data, ranging from routine process executions and performance metrics to errors and system alerts, thereby ensuring that diagnostic information is captured in real time. In the context of monitoring and capturing operational data of a monitored electronic system, “real time” refers to a process where data is at least captured within a predetermined maximum latency from the moment an event occurs in the monitored electronic system. More specifically, real time means that the interval between the occurrence of an event and the availability and capture of a corresponding set of event-related operational data is less than a specified threshold (e.g., about 100 milliseconds), thereby ensuring that the state of the monitored electronic system is continuously and accurately tracked. By leveraging advanced hardware components and specialized software routines, diagnostic logging systems can detect events defined by component/subcomponent operations occurring at extremely short intervals measured in fractions of a millisecond or less. This capability allows diagnostic logging systems to provide comprehensive, time-stamped records of an electronic system's behavior that can be used for troubleshooting, performance optimization, and security auditing. The automated, component-level and/or subcomponent-level system health monitoring performed by diagnostic logging systems enables the detection and resolution of issues that would not be feasible or practical to detect and resolve manually.

Diagnostic logging systems can capture, process (or analyze) and write (or record) a variety of types of diagnostic information. For convenience, the various types of diagnostic information can be categorized as, for example, “extended” context information, “non-extended” context information, and “payload” information. The “payload” category of information in a diagnostic log record (or diagnostic log entry, or diagnostic event record, or diagnostic event entry) contains the actual event-specific message, which explains what happened. Where the monitored electronic system is a database having a DBMS, the payload information can be represented with entries such as “Query executed: SELECT*FROM users” and “Deadlock detected: Transaction 98765 rolled back.” The payload information (or message) “Query executed: SELECT*FROM users” indicates that a database query was run to retrieve all records from the “users” table, which is basic structured query language (SQL) syntax. SQL is a domain-specific language used to manage data, especially in a relational database management system. Similarly, the payload information (or message) “Deadlock detected: Transaction 98765 rolled back” communicates that a deadlock was identified, A deadlock is a situation where two or more transactions are waiting indefinitely for each other to release locks. In this situation, the deadlock caused the system to abort and roll back transaction 98765.

While payload information delivers the substantive details of the event, the non-extended context and extended context categories of information frame the event within a precise time and system component. Again, where the monitored electronic system is a database having a DBMS, the non-extended context information in a diagnostic log record can identify that at “2025-03-20 12:03:15,” the “Transaction Manager” reported an “ERROR.” The non-extended context information in a diagnostic log file can include fundamental metadata such as the timestamp, severity level, and the system component that generated the event. Metadata can be described as “data about data” in that it provides descriptive information that characterizes, explains, or provides context for other data, making it easier to retrieve, use, and manage.

The extended context information builds upon the above-described non-extended context information by providing additional details that further describe the circumstances of the event. The additional details can include specific transaction identifiers (e.g., “Transaction ID: ABC123”), the precise SQL query executed (e.g., “UPDATE orders SET status=‘shipped’ WHERE order_id=98765”), error codes, resource utilization metrics (e.g., CPU or memory usage), and stack traces.

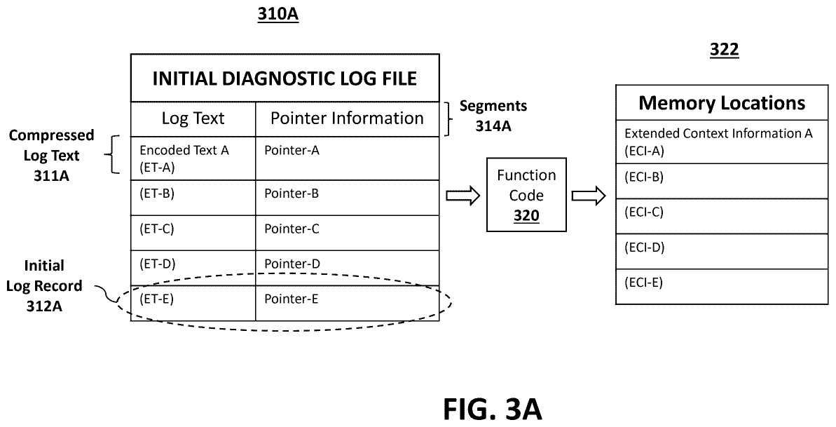

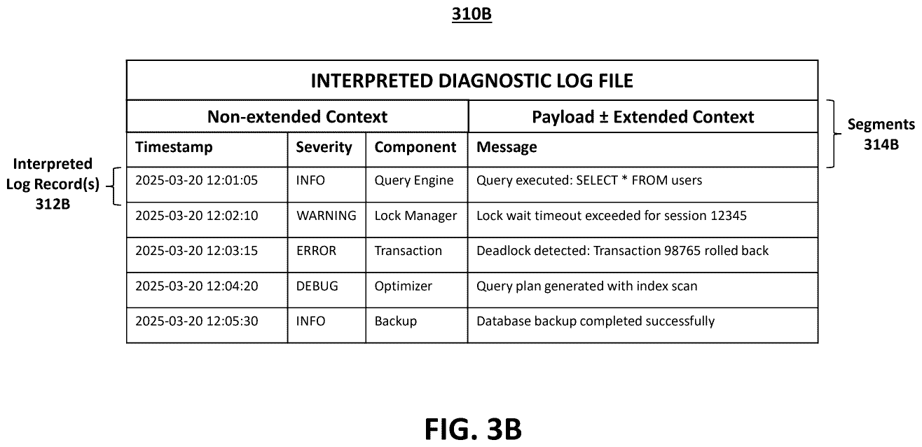

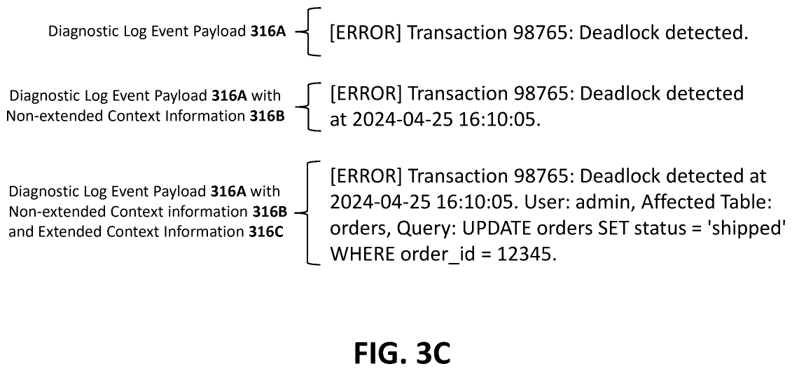

FIG. 3B depicts a non-limiting example of how payload information, non-extended context information, and extended context information can be organized in a diagnostic log file. The non-extended context information can be recorded under dedicated segments or columns of the diagnostic log file. The payload and the extended context information can be recorded in a message segment or column of the diagnostic log file. System administrators and/or automated analysis tools can access and utilize the context information and the extended context information to gain a more comprehensive understanding of the event and improve post-event troubleshooting and post-event root cause analysis. FIG. 3B as utilized in accordance with embodiments of the invention is described in greater detail subsequently herein.

Although access to non-extended and extended context information improves post-event troubleshooting and post-event root cause analysis, there are challenges with capturing and writing non-extended and/or extended context information in diagnostic logging systems. For example, writing relatively large amounts of non-extended context information and/or extended context information into a diagnostic log file consumes a relatively large amount of processor time and/or processor resources, particularly where the associated event is some form of an error event. For example, a diagnostic log record containing, a timestamp, severity indicator, a component indicator, and a brief message can occupy about two hundred (200) to five hundred (500) bytes. In comparison, a set of extended context information that includes additional detailed data/information such as execution plans, stack traces, transaction identifiers, and/or resource metrics can expand the previously-described diagnostic log record size to two (2) kilobytes or more. In some high-performance monitored electronic systems, the extended context information can represent a four-fold to ten-fold increase in size for a given diagnostic log record. The processor time/resources required to write such relatively large amounts of non-extended and/or extended context information for each event can impose significant performance overhead on the computing resources that implement the diagnostic logging system and/or the monitored electronic system (e.g., a database and its associated DBMS). When extensive non-extended and/or extended context details are written, the processor resources that implement the diagnostic logging system and/or the monitored electronic system must devote additional CPU cycles to process, format, and write the extra data, which can delay the completion of critical transactions. For example, where the monitored electronic system is a database and its DBMS, if the DBMS logs a full stack trace and detailed query execution plans for every query, the increased processing time and I/O load can lead to slower query response times and reduced throughput. Moreover, the added burden on memory and disk resources can result in resource contention, potentially causing increased latency or even timeouts during high-load conditions.

Known diagnostic logging systems address the above-described difficulties with writing relatively large amounts of information to diagnostic log files by reducing and/or minimizing the amount of non-extended and/or extended context information the diagnostic logging system records when problematic events happen. In some diagnostic logging systems, the above-described problems with writing relatively large amounts of information to diagnostic log files is addressed by, under some circumstances, eliminating capturing and writing the extended and/or non-extended context information altogether. Reducing and/or eliminating the capture and/or writing of non-extended and/or extended context information when problematic events happen makes post-event troubleshooting and post-event root cause analysis more difficult, less effective, and in some situations impossible to perform. When contextual information is not captured and written in real time, it cannot be later acquired. For example, where an error event is caused by the concurrent execution of certain software applications, and the error event does not occur when the software applications are not executing concurrently, the fact that certain software applications were executing concurrently when the error event occurred cannot be determined if the relevant operational data associated with software applications that were executing concurrently with the event is not captured and written at or near the time the event was captured and/or detected. Additionally, where large volumes of error-related or warning-related information are written in diagnostic log records, some error-related or warning-related information will be repeated many times, thereby increasing input/output (I/O) overhead and further reducing monitored electronic system performance.

Embodiments of the invention address the above-described and other challenges with writing relatively large amounts of data into diagnostic log records by providing computing systems, computer-implemented methods, and/or computer program products that capture a relatively large amount (or volume) of data/information (e.g., non-extended and/or extended context information) while reducing the processor time and computing resources that are required in order to write the relatively large amount of data/information into a diagnostic log record. In embodiments of the invention, a first selected portion of the event-related information that would, without benefit of embodiments of the invention, be written into a diagnostic log record is identified. Instead of writing the first selected portion of the event-related information into a diagnostic log record, a shorthand technique is applied to the first selected portion of the event-related information to generate a shorthand version of the first selected portion of the event-related information. The shorthand version of the first selected portion of the event-related information uses fewer bits (or bytes), takes up less disk space, and takes less processor time/resources to write than the original, non-shorthand version of the first selected portion of the event-related information.

In some embodiments of the invention, the first selected portion of the event-related information can be any combination of event-related payload information, non-extended context information, and extended context information that can be efficiently and effectively compressed. In some embodiments, the determination of whether the event-related payload information, non-extended context information, and extended context information can be efficiently and effectively compressed is based upon the historical frequency of the event-related payload information, the non-extended context information, and the extended context information occurring over the routine operations performed by the monitored electronic system. For example, where the monitored electronic system is a database and its associated DBMS, routine operations generate a high frequency of diagnostic log records that document standard DBMS activities that are essential for maintaining DBMS and database performance and stability. For instance, each executed database query can produce a log record that includes metadata such as the severity level, and the specific component (e.g., the query processor) involved. The payload of these records can contain details about the SQL statement executed, the execution time, and any minor warnings or informational messages that occurred during processing. A given category of DBMS and database operations can product log records that occur repeatedly during normal DBMS and database operations.

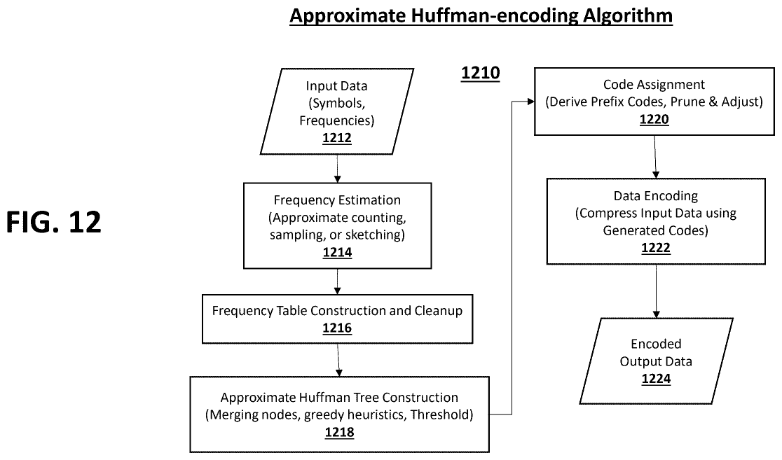

In some embodiments of the invention, the shorthand technique applied to the first selected portion of the event-related information is a compression technique. In some embodiments of the invention, the compression technique is a lossless compression technique. Lossless compression reduces the size of a data set without any loss of the information in the original data set, thereby enabling the exact original data to be reconstructed upon decompression. In some implementations, lossless compression specifically targets frequently occurring event-related information for its shortest length encoding. Applying short-length encodings to frequently occurring redundancies makes the encoding process more efficient. Non-limiting examples of suitable lossless compression techniques include algorithms such as Huffman coding, Lempel-Ziv-Welch (LZW), and Run-Length Encoding (RLE), where each employs its own tactics to achieve lossless compression. In some embodiments of the invention, the lossless compression technique is an approximate Huffman encoding algorithm, an example of which is depicted in FIG. 12 and described in greater detail subsequently herein.

Where the event-related payload information, the non-extended context information, and/or the extended context information is relatively unique (i.e., has no history of occurring frequently in the monitored electronic system), it is not a strong candidate for inclusion in the first selected portion of the event-related information. Due to its high degree of uniqueness, extended context information is most likely to not be a strong candidate for inclusion in the first selected portion of the event-related information.

In embodiments of the invention, information that is not a strong candidate for inclusion in the first selected portion of the event-related information can be a second selected portion of the event-related information. The second selected portion of the event-related information can be non-extended and or extended context information that would, without benefit of embodiments of the invention, not be written in the diagnostic log record (or written with the associated additional computer time/resource consumption). In embodiments of the invention, the second selected portion of the event-related information is instead stored in a memory location of a designated memory. In some embodiments of the invention, the designated memory is a cache memory. Writing the second selected portion of the event-related information in a diagnostic log record typically involves writing structured, timestamped event data to a persistent storage medium (e.g., a disk file or a database table) for long-term retention, analysis, and auditing. In contrast, storing a data set in a memory such as cache memory is a temporary, volatile storage approach designed to provide rapid access and reduce latency during program execution. While diagnostic log records are intended for retrospective examination and are optimized for reliable, sequential writes, cached data is transient and prioritized for speed, allowing frequently accessed information to be quickly retrieved by the processor. Thus, diagnostic log files offer durability at the expense of write speed, whereas cache memory supports high-speed processing with the trade-off of potential data loss if power is lost or the system is rebooted. More specifically, where the second selected portion of the event-related information is non-extended context information and/or extended context information, writing such non-extended and/or extended context information to a log record involves formatting the data and then performing synchronous or asynchronous writes to persistent storage, such as a hard drive or SSD, which inherently have higher latencies compared to operations performed in memory. File system write operations entail additional overhead such as system calls, locking, buffering, and error-checking, all of which increase CPU utilization and input/output (I/O) wait times. In contrast, storing non-extended and/or extended context information in memory (and particularly cache memory) leverages high-speed, low-latency storage that is directly accessible by the CPU. Cache memory, which is designed for rapid read/write operations, allows the system to temporarily hold data without the slower processing required by disk-based operations. Consequently, by retaining non-extended and/or extended context information in memory rather than writing it to disk, embodiments of the invention enable a diagnostic logging system to operate more efficiently, reducing the performance penalty associated with expensive I/O operations and ultimately using fewer computer resources and less time.

In some embodiments of the invention, the second selected portion of the event-related information can be information that is voluminous and/or likely to be unique to the particular event with which it is associated. For example, the second selected portion of the event-related information can be extended context information. Where the monitored electronic system is a database having a DBMS, an error event can be influenced by another application such that the error event only occurs when a particular database task is performed while the other application is executing. The extended context information included in the second selected portion of the event-related information can include details about the other application and what specific tasks the other application was performing when the error event occurred. As an example, if “error event A” occurs exclusively when “Application A is running,” the diagnostic logging system can capture a wealth of real time, application-specific information to enrich the extended context information (i.e., the second selected portion of the event-related information) for error event A. The diagnostic logging system can capture the version of “Application A,” the specific module or process in which the error occurred, and the corresponding session or user IDs associated with the operation. The diagnostic logging system can also capture runtime metrics such as the CPU and memory utilization, active thread or process identifiers, and the sequence of API calls leading up to the error. Additionally, configuration settings, application-specific variable states, and cached data snapshots at the time of the error event can be recorded to provide a complete picture of the operational environment. This detailed context aids developers and system administrators in understanding the exact conditions under which “error event A” occurred, facilitating more precise troubleshooting, root cause analysis, and problem resolution.

In accordance with embodiments of the invention, information (e.g., pointer information) that identifies the location of the second selected portion of the event-related information is generated and attached to the shorthand (i.e., encoded) version of the first selected portion of the event-related information. The shorthand version of the first selected portion of the event-related information and its associated pointer information are written in a diagnostic log record of the diagnostic log file. The shorthand version of the first selected portion of the event-related information and its associated pointer information occupy less disk space and take less computer time and computer resources to write than it would take to write the original version of the first selected portion of the event-related information and the complete second selected portion of the event-related information in a diagnostic log record. In some embodiments, the efficiency of diagnostic logging operations is further improved by performing the writing and/or memory storage operations asynchronously in order to not interfere with DBMS, database, and other computer operations associated with the monitored electronic system.

The above-described operations performed in accordance with embodiments of the invention result in an “initial” diagnostic log file and memory locations of an associated memory. A non-limiting example of an “initial” diagnostic log file and an associated memory in accordance with embodiments of the invention are the initial diagnostic log file 310A and the memory 322 depicted in FIG. 3A. The log records of the “initial” diagnostic log file are organized around segments 314A that include “Log Text” and “Pointer Information.” The Log Text segment include shorthand (i.e., “encoded”) versions of the first selected portion of the event-related information. If extended context information was associated with the event, the extended context information is captured within an extended context capture time window around the event and stored in a memory location. The Pointer Information segment identifies that the memory location(s) in the associated memory is associated with the first selected portion of the event-related information and stored in the initial log record (e.g., initial log record 312A shown in FIG. 3A) that includes the shorthand version (e.g., compressed log text 311A shown in FIG. 3A) of the first selected portion of the event-related information. Log records can also be referred to herein as log entries, or event records, or event entries.

Although the encoded information and pointer information in the initial log record uses fewer bits/bytes of information than the original unencoded log record information, the shorthand version of extended context information is deliberately designed to be a compact representation that encodes all of the details of the original extended context information. Although this shorthand format is not immediately human-readable, it is fully reversible such that the original extended context can be completely recaptured by running it through the appropriate decoding process. Using a reversible shorthand technique (e.g., approximate Huffman-encoding) ensures that no data/information is lost during the encoding and writing process, the full context remains available for analysis when needed, and processor overhead (time and resources) associated with writing verbose extended context event-related information is minimized.

Under conventional operations of a diagnostic logging system operating without benefit of embodiments of the invention, a log interpreter can be configured to ingests the log data stored in a diagnostic log storage of the diagnostic logging system. The log interpreter parses and normalizes the log data; categorizes errors; correlates events; and prepares the log data for further analysis by a diagnostic analyzer of the diagnostic logging system. In embodiments of the invention, a log interpreter of the diagnostic logging system is configured to, when needed, perform decoding operations on the “initial” diagnostic log file records/entries to recover the unencoded contents of the “initial” log file record/entry and use the pointer information to access extended context information from the memory location where it was stored. The log interpreter can create an “interpreted” log file record by writing the unencoded contents of the “initial” diagnostic log file record/entry and the downloaded extended context information into a diagnostic log file record of the interpreted diagnostic log file. In some embodiments of the invention, the above-described functions of the log interpreter, in accordance with embodiments of the invention, can be called by an asynchronous log reader locally, and can also be called by any local or remote log interpreter using an application programming interface (API). The interpreted diagnostic log file records can be generated and/or accessed to perform post-event troubleshooting and/or post-event root cause analysis. The interpreted diagnostic log file records can be written asynchronously in a manner that does not place an overhead burden on processor time/resources used by the various computer functions associated with the diagnostic logging system and the monitored electronic system (e.g., a database having a DBMS).

Accordingly, embodiments of the invention address the previously-described and other challenges with writing relatively large amounts of data into diagnostic log file records by providing computing systems, computer-implemented methods, and/or computer program products that utilize selective encoding and cache memory storage techniques to capture a relatively large amount (or volume) of data/information (e.g., non-extended and/or extended context information) as encoded portions and memory-stored portions of the relatively large amount of data/information. The processor time and computing resources that are required in order to write the encoded portions to a diagnostic log file and store the memory-stored portions to a memory (e.g., cache memory) are significantly less than the processor time and computing resources requires to write the unencoded version of the encoded portions of the relatively large amount of data/information, as well as the memory-stored portions of the relatively large amount of data/information directly into a diagnostic log record.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as writing and extending diagnostic log files code 200. In addition to the writing and extending diagnostic log files code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

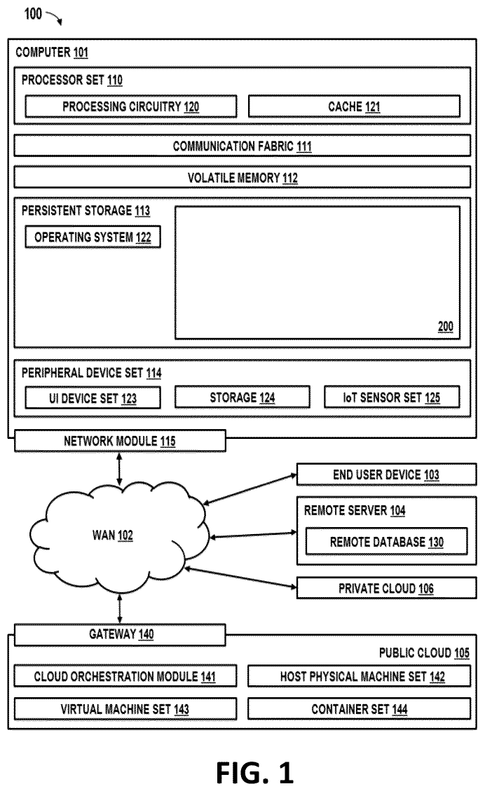

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in the code 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

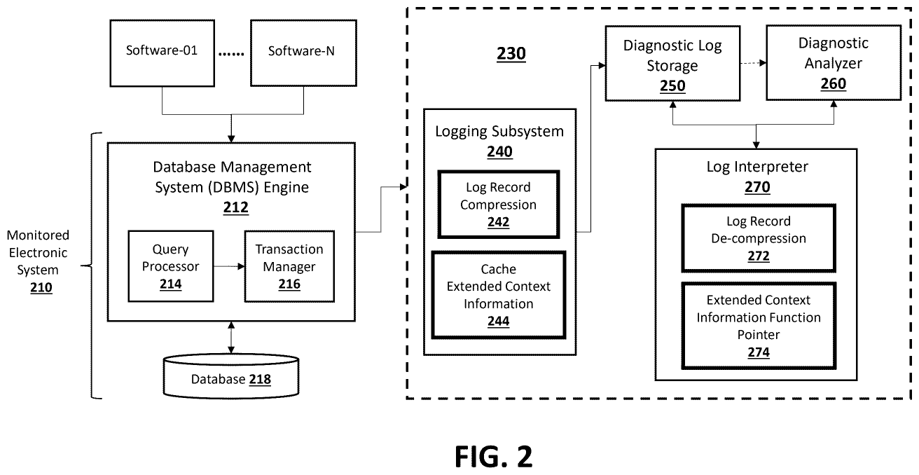

Turning now to a more detailed description of aspects of the invention, FIG. 2 depicts a non-limiting example of a monitored electronic system 210 and a diagnostic logging system 230 embodying aspects of the invention. The monitored electronic system 210 and the diagnostic logging system 230 can be implemented using some or all of the features and functionality of the computing environment 100 shown in FIG. 1. In some embodiments of the invention, the monitored electronic system 210 can be a database 218 having a DBMS implemented as a DBMS engine 212. The DBMS engine 212 includes a query processor 214 and a transaction manager 216. Multiple software programs, which are shown in FIG. 2 as Software-01 through Software-N (where N =a whole number), communicate electronically with the DBMS engine 212 and the database 218 to perform a variety of database-related operations including, for example, configuring, searching, loading, and downloading data/information. The components/modules of the monitored electronic system 210, Software-01 through Software-N, and the diagnostic logging system 230 illustrated in FIG. 2 are depicted separately for ease of illustration and explanation. In embodiments of the invention, the functions performed by the components/modules in FIG. 2 can be distributed differently than shown without departing from the scope of the various embodiments of the invention describe herein unless it is specifically stated otherwise.

Software-01 through Software-N are multiple instances of software that enable an end-user or another software instance to perform computing tasks that require interaction to some extent with the database 218, including tasks such as creating documents, creating spreadsheets, creating database instances, creating publications, performing online research, sending email, designing graphics, and playing games. The term “software” refers to the set of electronic program instructions or data a computer processor reads in order to perform a task or operation. There are two main categories of software, namely, systems software and application software. Systems software includes computer programs that are dedicated to managing the computer itself such as the operating system, file management utilities, and disk operating system (or DOS). Systems software serves as an intermediary between application software and computer hardware that manages resources, processes, memory, file systems, and input/output (I/O) operations. This coordination allows software programs to function efficiently and effectively, thereby enabling users to perform a wide range of tasks on their computers.

Application software is specific to a task or tasks for which it was designed and can be as simple as a calculator application or as complex as a word processing application. Each instance of application software can be associated with a particular application domain. A “software application domain” refers to the specific area or context in which a software application operates and is designed to serve. The domain of a software application encompasses the particular problems the software application aims to solve, the target users, and the industry or field with which it is associated. Examples of software application domains include, for example, healthcare (e.g., managing patient records, scheduling, billing, and telemedicine), education (e.g., learning management system (LMS) and educational tools), and gaming (e.g., application software designed for entertainment and gaming experiences).

The database 218 is a systematically organized collection of data/information that is stored and managed to support efficient access, modification, and retrieval. In some embodiments of the invention, the database 218 can be implemented as a relational database. In relational databases, data/information is structured into tables having rows and columns, where each table represents a specific entity or concept, and the relationships among these tables are maintained through keys. A relational database leverages structured query language (SQL) to perform operations such as data retrieval, updates and complex joins across related tables, thereby ensuring data integrity and consistency through predefined constraints and relationships.

The DBMS engine 212 acts as the intermediary between users, software applications (e.g., Software-01 through Software-N), and the database 218 by providing a suite of tools for data manipulation, transaction management, and security enforcement. The DBMS engine 212 controls access to the data, manages concurrent operations to prevent conflicts, and ensures robust performance through indexing, query optimization, and backup routines, thereby enabling the efficient and reliable use of data resources.

The DBMS engine 212 includes a query processor 214 and a transaction manager 216. The query processor 214 serves as the interface between submitted SQL queries and the physical data stored in the database 218. The query processor 214 performs operations that enable efficient data retrieval and manipulation. Initially, the query processor 214 parses and validates the SQL statement to ensure it adheres to syntax rules and database schema constraints. Once validated, the query is translated into an internal representation, and sophisticated optimization algorithms are applied to generate an optimal execution plan by analyzing various query execution strategies and selecting the one that minimizes resource utilization and execution time. Finally, the optimized query plan is executed, with the query processor 214 coordinating the retrieval of data from the database 218, applying the necessary operations (e.g., joins, sorting, and filtering), and delivering the results back to the source of the query (e.g., Software-01 or a user query submitted through Software-01).

The transaction manager 216 is responsible for ensuring the integrity and consistency of the database 218 by managing all aspects of transaction processing. The transaction manager 216 oversees the execution of database transactions by enforcing the ACID (atomicity, consistency, isolation, durability) properties, which guarantee that transactions are processed reliably even in the presence of system failures or concurrent operations. The database transactions include operations such as initiating transactions, coordinating the commit or rollback of transactions based on the success or failure of underlying operations, managing locks to enforce isolation, and logging transaction activities through the diagnostic logging system 230 for recovery purposes. The transaction manager 216 closely interacts with the query processor 214. While the query processor 214 parses, validates, and optimizes SQL queries and generates an execution plan, the transaction manager 216 encapsulates these operations within a transactional context and ensures that the results of the query executions performed by the query processor 214 are applied atomically and consistently, thereby bridging the gap between individual query execution and overall transaction integrity across the database DBMS engine 212 and the database 218.

The query processor 214 uses algorithms represented as code and/or routines configured to parse, optimize, and execute SQL queries. The code and/routines of the query processor 214 are executed by the underlying hardware of the DBMS engine 212, which includes a CPU, memory, and storage devices/systems. Similarly, the transaction manager 216 uses algorithms represented as code and/or routines configured to manage transactions, enforce ACID properties, and coordinate commits or rollbacks of database operations. The code and/or routines of the transaction manager 216 are executed by the underlying hardware of the DBMS engine 212, which includes a CPU, memory, and storage devices/systems. As used herein, the terms “memory,” “memory systems,” and equivalents thereof refer to primary, volatile storage (e.g., random-access memory (RAM)), which provides fast, temporary data storage for active processing by the CPU. In contrast, the terms “storage,” “storage devices,” “storage systems,” and equivalents thereof refer to non-volatile secondary storage media, such as hard disk drives (HDDs) or solid-state drives (SSDs), which are used to persistently store data even when the system is powered off. While memory is used for rapid data access during the execution of tasks, storage devices/systems are optimized for long-term data retention and are accessed at relatively slower speeds.

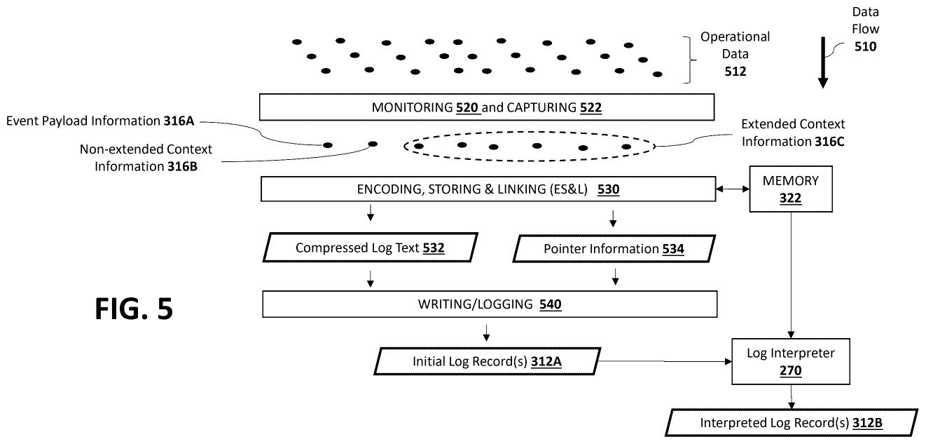

The diagnostic logging system 230 is configured to detect events in monitored electronic system 210 by monitoring and capturing operational data (e.g., operational data 512 shown in FIG. 5) generated by the monitored electronic system 210 during operations performed by the monitored electronic system 210. “Monitoring” operational data refers to the continuous observation of system activities, parameters, and operational states without necessarily storing or acting upon every piece of observed data. The monitored operational data includes, for example, system metrics such as CPU usage, query execution times, and/or error states. “Capturing” operational data is the process of actively selecting and extracting specific monitored operational data that meets predefined conditions. The diagnostic logging system 230 is configured to apply predefined filters, rules, or thresholds to monitored operational data to identify operational data that represents events that may or may not warrant further action. The detected events range from routine process executions and performance metrics to errors and system alerts. By leveraging advanced hardware components and specialized software routines, the diagnostic logging system 230 can process instances of operational data representing operations separated from one another by extremely short intervals or time gaps, which are often measured in fractions of a millisecond. The data monitoring, data capturing, and event detection capabilities of the diagnostic logging system 230 enable the diagnostic logging system 230 to provide comprehensive, time-stamped records of system behavior (e.g., events) that can be used for troubleshooting, performance optimization, and security auditing. Ultimately, the diagnostic logging system 230 serve as an automated backbone for monitoring system health of the monitored electronic system 210, thereby enabling rapid detection and resolution of system issues that would not be feasible to detect and resolve manually. The diagnostic logging system 230 also performs recording operations of event-related information. “Recording” information/data refers to the act of permanently storing (or writing) captured and analyzed information/data in a persistent medium, such as a log file, database, or external storage system. Recording ensures that the information/data is available for later retrieval, analysis, and auditing.

In embodiments of the invention where the monitored electronic system 210 is the DBMS engine 212 and the database 218, the monitored events primarily occur within the DBMS engine 212 rather than in the database 218. The DBMS engine 212 executes a software layer that manages the interaction between users and the underlying database 218, handling operations such as query processing, transaction management, indexing, memory usage, and access control. As such, most events relevant to diagnostic logging (e.g., query execution failures, lock timeouts, transaction rollbacks, and system resource thresholds) originate within the operational processes of the DBMS engine 212. The database 218, on the other hand, is the structured collection of data that the DBMS engine 212 manages. The database 218 does not itself perform operations but rather serves as the target and source of data manipulated by the DBMS engine 212. Therefore, while diagnostic log records may reference specific elements of the database 218 (e.g., tables, indexes, or stored procedures), the actual events being monitored and logged occur within the functioning of the DBMS engine 212.

The diagnostic logging system 230 includes a logging subsystem 240, a diagnostic log storage 250, a diagnostic analyzer 260, and a log interpreter 270, configured and arranged as shown. The diagnostic logging system 230 performs the previously-described monitoring and capturing of operational data (e.g., operational data 512 shown in FIG. 5) generated by operations performed by or occurring within the monitored electronic system 210 (e.g., the database 218 and the DBMS engine 212) to facilitate real-time monitoring, real time capturing, post-event troubleshooting, and/or post-event root cause analysis. The operational data is monitored and captured through integrated sensors, event listeners, or hooks within the operating environment (e.g., the monitored electronic system 210 and/or Software-01 through Software-N shown in FIG. 2). The logging subsystem 240 converts the captured operational data from its raw data format into standardized formats (e.g., SQL). In the logging subsystem 240, specialized formatting routines convert or transform the formatted (e.g., SQL) captured operational data into a structured, SQL-compatible format (e.g., inserting the captured operational data into rows and columns of a logging table) so that it can be easily queried and analyzed later using SQL queries. This conversion ensures that the subsequently recorded/written diagnostic log records (e.g., compressed log text 311A and initial log records 312A shown in FIG. 3A; and/or interpreted log records 312B shown in FIG. 3B) can be stored in a relational format that supports efficient retrieval, correlation, and analysis by the diagnostic analyzer 260 or other database tools while preserving the integrity and accessibility of the logged information. The captured and formatted information can include not only high-level descriptive messages but also structured context such as timestamps, severity levels, component identifiers, and other key metadata that provide foundational insights into the detected events. As previously-described herein, the captured and formatted information can be organized into categories or segments (e.g., segments 314B shown in FIG. 3B) including, for example, “extended” context information, “non-extended” context information, and “payload” information. “Payload” and “extended context” information can be associated with a category/segment identified as a “message.” “Non-extended context” information can be associated with categories/segments that provide additional detail about the “non-extended context” information, including, for example “timestamp,” “severity,” “component,” and the like. At this stage of the operations performed by the diagnostic logging system 230, the captured and formatted information can represent a relatively large amount of data, particularly where the event represented by the captured and formatted information is an anomalous event that will require a meaningful level of post-event troubleshooting and/or post-event root cause analysis.

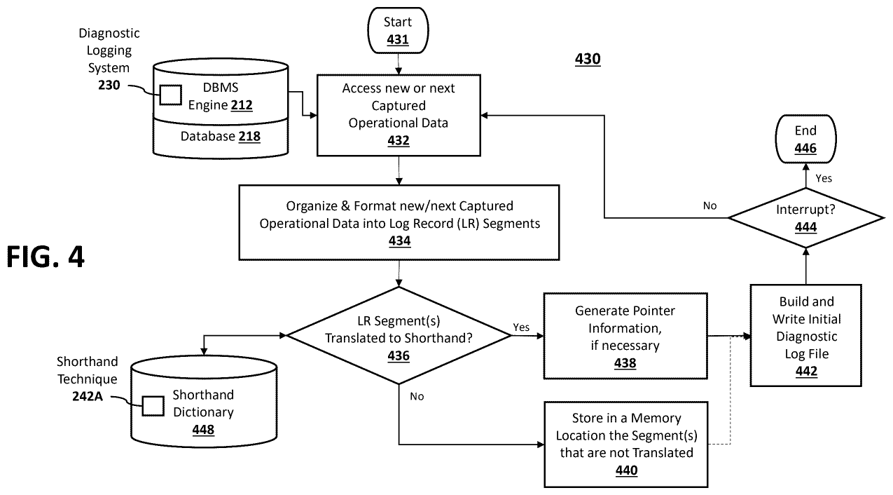

In accordance with embodiments of the invention, the logging subsystem 240 includes log record compression functionality 242 and cache extended context information functionality 244 configured and arranged to address the previously-described and other challenges with writing relatively large amounts of data (e.g., two (2) kilobytes or more) into diagnostic log records. The log record compression functionality 242 and the cache extended context information functionality 244 provide computing systems, computer-implemented methods, and/or computer program products that capture a relatively large amount (or volume) of data/information (e.g., non-extended and/or extended context information) while reducing the processor time and computing resources that are required in order to write the relatively large amount of data/information into a diagnostic log record. More specifically, the log record compression functionality 242 and cache extended context information functionality 244 are used to generate abridged versions of the previously-described captured and formatted information. In accordance with embodiments of the invention, the captured and formatted information is organized into records, and the captured and formatted information in each record is organized into record segments. The log record compression functionality 242 evaluates the record segments to identify record segments that are candidates for having a shorthand technique applied to them. In some embodiments of the invention, the shorthand technique is a compression technique. In some embodiments of the invention, the compression technique is a lossless compression technique. In some embodiments of the invention, the lossless compression technique is the method 1210 shown in FIG. 12 and described in greater detail subsequently herein. In some embodiments of the invention, the evaluation of whether a record segment is a candidate for being compressed is a use frequency and length of the record segment evaluated over a predefined or predetermined operating period of the monitored electronic system 210. In some embodiments of the invention a dictionary (e.g., shorthand dictionary 448 shown in FIG. 4) can be generated using the lossless compression technique to create a dictionary or listing of candidate log records and their corresponding encodings such that a candidate log records encoding can be looked up using the dictionary. The record segments that can be compressed are compressed by the log record compression functionality 242 such that each abridged/compressed record segment occupies fewer bits or bytes than the unabridged/uncompressed version of the record segment.

For the record segment(s) that are not candidates for having the shorthand technique applied to them (e.g., due to any combination of uniqueness, infrequency and length of the record segment), the cache extended context information functionality 244 stores the record segment(s) in a memory (e.g., memory 322 shown in FIG. 3A) and generates pointer information that associates the stored record segment with its record. In embodiments of the invention, the record segments that are not good candidates for having the shorthand technique applied to them include extended context information, which can be relatively large (e.g., two (2) kilobytes or more) and relatively unique.

The diagnostic log storage 250 writes the abridged records generated at the logging subsystem 240 to a designated persistent storage medium, such as a file system, database table, or cloud-based logging service. FIG. 3A depicts a non-limiting example of an “initial” diagnostic log file 310A and a memory 322 that can be used in accordance with embodiments of the invention to hold the abridged records. The “initial” diagnostic log file 310A includes initial log records 312A that each include abridged/compressed log text 311A and pointer information (e.g., Pointer-A). Extended context information (e.g., ECI-A) associated with the initial log record 312A is stored in a memory location of the memory 322, and the pointer information is configured and arranged to point to the memory location of the memory 322 where the extended context information (e.g., ECI-A) is stored. By compressing selected portions of the log record and storing the extended context information associated with the initial log record 312A in the memory 322, the processor time and computing resources that are required in order to write the compressed log text 311A and the pointer information (e.g., Pointer-A) to the initial diagnostic log file 310A, as well as the processor time and computing resources that are required in order to store the extended context information (e.g., ECI-A) in the memory 322, are reduced from the processor time and computing resources that would have been required to write a non-compressed, non-memory-stored version of the initial log record 312A into a diagnostic log file. Additional details of the operations performed by the log record compression functionality 242 and the cache extended context information functionality 244 in accordance with embodiments of the invention are depicted in FIG. 4 and FIG. 5 and described subsequently herein.

In accordance with embodiments of the invention, the initial diagnostic log file 310A generated and written by the logging subsystem 240 and the diagnostic log storage 250 must be interpreted before it can be analyzed by the diagnostic analyzer 260. Under conventional operations of a diagnostic logging system operating without benefit of embodiments of the invention, a log interpreter can be configured to ingests the log data stored in a diagnostic log storage of the diagnostic logging system. The log interpreter parses and normalizes the log data; categorizes errors; correlates events; and prepares the log data for further analysis by a diagnostic analyzer of the diagnostic logging system. The log interpreter 270, operating in accordance with aspects of the invention, is configured to use log record decompression functionality 272 and the extended context information function pointer functionality 274 to generate the interpreted diagnostic log file 310B shown in FIG. 3B. The log record decompression functionality 272 reverses the shorthand technique applied by the log record compression functionality 242 to generate from the compressed log text 311A (e.g., ET-A) of the initial log record 312A shown in FIG. 3A portions (e.g., a reversed record portion) of the interpreted log record 312B. The extended context information function pointer functionality 274 is configured to utilize Pointer-A of the initial log record 312A to determine the memory location in the memory 322 where the extended context information (ECI-A) is stored. In some embodiments of the invention, the extended context information function pointer functionality 274 uses Pointer-A to call a function code 320, the function code 320 retrieves ECI-A from the memory 322, and the extended context information function pointer functionality 274 uses the retrieved ECI-A to build the remaining portions of the interpreted diagnostic log file 310B.

The log interpreter 270 provides the interpreted log record 312B of the interpreted diagnostic log file 310B to the diagnostic analyzer 260. To transform the interpreted log record 312B of the interpreted diagnostic log file 310B into actionable insights, the diagnostic analyzer 260 processes the interpreted log record 312B of the interpreted diagnostic log file 310B utilizing, for example, sophisticated algorithms to correlate events, detect anomalies, and identify potential issues by aggregating and visualizing key trends.

FIGS. 3B and 3C depict a non-limiting example of how segments 314B of the interpreted diagnostic log file 310B can be organized as a payload information segment, non-extended context information segment, and an extended context information segment. The non-extended context information can be recorded under additional, dedicated segments or columns of the interpreted diagnostic log file 310B, including, for example, a timestamp segment, a severity level segment, and a system component segment that identifies the system component that generated the event. The payload and the extended context information can be written/recorded collectively in a message segment or column of the integrated diagnostic log file 310B.

FIG. 3C depicts non-limiting examples of a diagnostic log event payload 316A, non-extended context information 316B, and extended context information 316C that can be in the interpreted diagnostic log file 310B shown in FIG. 3B. For the examples depicted in FIG. 3C, the monitored electronic system 210 is the database 218 and the DBMS engine 212. In the diagnostic log event payload 316A, “[ERROR] Transaction 98765: Deadlock detected” indicates that the DBMS engine 212 encountered a deadlock condition during the execution of transaction 98765. In this context, the “[ERROR]” prefix signals that the event is considered a significant failure, while the transaction identifier “98765” specifies which transaction was affected. A deadlock occurs when two or more transactions lock resources in such a manner that each transaction waits indefinitely for the other to release its locks, thus preventing any of them from proceeding. The diagnostic log event payload 316A serves as an alert to database administrators and/or automated recovery tools that intervention may be necessary to resolve the resource contention and restore normal operation. In the non-extended context information 316B, “Deadlock detected at 2024-04-25 16:10:05” indicates that the deadlock occurred at precisely 16:10:05 on Apr. 25, 2024. In the extended context information 316C, “User: admin, Affected Table: orders, Query: UPDATE orders SET status=‘shipped’ WHERE order_id=12345” provides in-depth details about the specific circumstances under which an event occurred within the DBMS engine 212 and the database 218. In this case, “User: admin” indicates that the administrative account initiated the operation, which is key for auditing and identifying the responsible party. “Affected Table: orders” specifies that the changes or the event impacted the ‘orders’ table, pinpointing the exact data structure involved. Finally, the “Query: UPDATE orders SET status=‘shipped’ WHERE order_id=12345” portion of the extended context information 316C offers the full SQL command executed, thereby detailing the precise change made, which is updating the status of an order with an ID of 12345 to “shipped.” This level of detail provided by the extended context information 316C not only supplements the fundamental even-related information, but also provides insights for post-event troubleshooting and post-event root cause analysis.

FIG. 4 depicts a flow diagram illustrating a non-limiting example of a method 430 in accordance with embodiments of the invention. The method 430 can be performed by the diagnostic logging systems 230 (shown in FIG. 2) while it is monitoring operational data (e.g., operational data 512 shown in FIG. 5) generated by the monitored electronic system 210 (FIG. 2). The method 430 starts at block 431 and moves to block 432. At block 432, the logging subsystem 240 (shown in FIG. 2) of the diagnostic logging system 230 accesses new instances or next instances of captured operational data from the monitored electronic system 210, and specifically from the DBMS engine 212 and/or the database 218. The operational data refers to the precise, real-time technical information generated during normal operations performed by the DBMS engine 212 and/or the database 218. The captured operational data encompasses metrics such as CPU utilization, memory consumption, disk I/O statistics, network throughput, transaction logs, and detailed event records, all of which are monitored continuously by integrated sensors, event listeners, or hooks throughout the DBMS engine 212, the database 218, and/or related systems (e.g., Software-01 through Software-N shown in FIG. 2). The operational data is highly granular and engineered to reflect the exact state and performance of the monitored electronic system 210 at any given moment, thereby enabling automated tools to monitor, capture, analyze, and troubleshoot behavior of the monitored electronic system 210 with pinpoint accuracy.

The method 430 moves to block 434 where the logging subsystem 240 has captured and formatted the operational data into, for example, an SQL format. The SQL formatted information is then organized into log record segments that correspond the various segments (e.g., segments 314B shown in FIG. 3B) of the diagnostic log records (e.g., interpreted log records 312B shown in FIG. 3B) in a diagnostic log file (e.g., interpreted diagnostic log file 310B shown in FIG. 3B). It should be noted that, although the captured and formatted information is organized around the structure used in log records, the step of actually writing information to a log record is performed at block 442, which is subsequent to the operations performed at decision block 436, block 438, and block 440. As previously-described herein, for convenience, the various segments of each diagnostic log record can be categorized as, for example, “extended” context information, “non-extended” context information, and “payload” information. The “payload” information in a diagnostic log record (or diagnostic log entry) contains the actual event-specific message, which explains what happened. While payload information delivers the substantive details of the event, the non-extended context and extended context information frame the event within a precise time and system component. The non-extended context information in a diagnostic log record can include fundamental metadata such as the timestamp, severity level, and the system component that generated the event. Metadata can be described as “data about data” in that it provides descriptive information that characterizes, explains, or provides context for other data, making it easier to retrieve, use, and manage. The extended context information builds upon the above-described non-extended context information by providing additional details that further describe the circumstances of the event. The additional details can include but are not limited to specific transaction identifiers, the precise SQL query executed, error codes, resource utilization metrics, and stack traces.

The method 430 moves to decision block 436 where, for each log record, the segments of event-related information (e.g., payload information, non-extended context information, and extended context information) generated at block 434 are each evaluated to determine whether a given segment of the event-related information in the log record can be translated to a shorthand version of the segment of the event-related information. The evaluation at decision block 336 can be performed by the logging subsystem 240 (shown in FIG. 2) using the log record compression functionality 242 (shown in FIG. 2). In some embodiments of the invention, the evaluation at decision block 436 can be performed using a shorthand dictionary (or translation dictionary) 448 and/or a shorthand technique (or translation technique) 242A. The shorthand dictionary 448 can be a frequency-based dictionary in which the most common symbols or values use the fewest bits to store. In some embodiments of the invention, the shorthand dictionary 448 can be built over time by applying the shorthand technique 242A (e.g., the approximate Huffman-encoding algorithm represented by the method 1210 shown in FIG. 12) to operations performed by the monitored electronic system 210 (shown in FIG. 2). In some embodiments of the invention, the shorthand technique 242A (e.g., the approximate Huffman-encoding algorithm represented by the method 1210 shown in FIG. 12) directly to the LR segments generated at block 434.

In some embodiments of the invention, the log record (LR) segments translated to shorthand versions can be any combination of event-related payload information, non-extended context information, and extended context information that can be efficiently and effectively compressed. In some embodiments, the determination of whether the LR segment can be efficiently and effectively compressed is based upon the historical frequency of the LR segment occurring over the routine operations performed by the monitored electronic system 210. For example, where the monitored electronic system 210 is the database 218 and its associated DBMS engine 212, routine operations generate a high frequency of diagnostic log records that document standard DBMS activities that are essential for maintaining the performance and stability of the database 218 and its associated DBMS engine 212. For instance, each executed database query can produce a log record that includes metadata such as the severity level, and the specific component (e.g., the query processor) involved. The payload of these records can contain details about the SQL statement executed, the execution time, and any minor warnings or informational messages that occurred during processing. A given category of DBMS and database operations can product log records that occur repeatedly during normal DBMS and database operations.

Because some LR segments are candidates for shorthand translation and some LR segments are not, a result of the evaluation at decision block 436 can be yes for all LR segments, no for all LR segments, or a combination of yes for some LR segments and no for some LR segments. The LR segments (e.g., payload information and/or non-extended context information) that generate a yes response to the evaluation at decision block 436 are translated. The LR segments (e.g., extended context information) that generate a no response to the evaluation at decision block 436 are not translated and are instead transmitted to block 440 where the non-translated LR segments are stored in a memory (e.g., memory 322 shown in FIG. 3A). The yes output from decision block 436 goes to block 438 where pointer information (e.g., Pointer-A shown in FIG. 3A) for the translated LR segments is generated, if necessary. For example, where the translated LR segments are routine payload information and/or non-extended context information, the diagnostic logging system 230 can determine that the routine payload information and/or non-extended context information does not merit the assembly and storage of extended context information. The general pointer information generated at block 438 points to and identifies the non-translated LR segment(s) stored in memory (e.g., memory 322 shown in FIG. 3A) that is associated with the translated LR segments generated by the yes output from decision block 436. At block 442, the method 430 uses the translated LR segment(s), the pointer information (if any), and the non-translated and stored LR segments to build an initial diagnostic log file and write the same to the diagnostic log storage 250 (shown in FIG. 2). The initial diagnostic log file generated at block 442 corresponds to the initial diagnostic log file 310A shown in FIG. 3A.

From block 442, the method 430 moves to decision block 444 to determine whether or not an interrupt request has been received. If the response to the inquiry at decision block 444 is yes, the method 430 moves to block 446 and ends. If the response to the inquiry at decision block 444 is no, the method 430 returns to block 432 and performs another iteration of the method 430.

FIG. 5 depicts a simplified block diagram illustrating a non-limiting example of system components (e.g., memory 322 and log interpreter 270), various data inputs/outputs (e.g., operational data 512, diagnostic log event payload 316A, non-extended context information 316B, extended context information 316C, compressed log text 532, pointer information 534, initial diagnostic log file 310A, and interpreted log records 312B), and computer-implemented functional operations (e.g., monitoring, 520; capturing 522; encoding, storing & linking (ES&L) 530; and writing/logging 540). The data flow 510 begins with monitoring 520 and capturing 522 operations applied to operational data 512 generated by the monitored electronic system 210 (shown in FIG. 2) and/or related systems (e.g., Software-01 through Software-N shown in FIG. 2).

The simplified block diagram shown in FIG. 5 reflects several operations and types of operations. A diagnostic logging system (e.g., the diagnostic logging system 230 shown in FIG. 2) can be configured to perform the monitoring 520 and the capturing 522. For example, the monitoring 520 performs continuous observation of operational data 512 (i.e., system activities, parameters, and operational states) without necessarily storing or acting upon every piece of monitored or observed operational data 512. The operational data 512 (or system metrics) can include, for example, CPU usage, query execution times, and/or error states. The capturing 522 including processes configured to actively selecting and extracting specific instances of the monitored operational data 512 that meets predefined or predetermined conditions. Diagnostic logging systems apply predefined filters, rules, or thresholds to monitored operational data 512 to identify, in real time, operational data 512 that represents events (e.g., errors, performance anomalies, or security threats) that may or may not warrant further action. Capturing operational data 512 in real time means that the operational data 512 is collected at substantially the same time that the operational data 512 is generated or made available within the system with substantially no latency between the availability and capture of the operational data 512. In a diagnostic logging system, real time operational data capture means that the operational data generated by system operations (e.g., a query execution, an error occurrence, or a change in resource usage) is captured at substantially the same time that it is generated or available.

The monitoring 520 and capturing 522 operations generate diagnostic log event payload 316A, non-extended context information 316B, and extended context information 316C, in any combination. ES&L 530 operations are applied to the diagnostic log event payload 316A, the non-extended context information 316B, and/or the extended context information 316C to generate compressed log text 532 (e.g., ET-A shown in FIG. 3A) and pointer information 534 (e.g., Pointer-A shown in FIG. 3A). Writing/logging 540 operations are applied to the compressed log text 532 and the pointer information 534 to generate the initial diagnostic log record(s) 312A (also shown in FIG. 3A). The log interpreter 270 is configured to, as described previously in connection with the diagnostic logging system 230 shown in FIG. 2, reverse the ES&L 530 operations to generate the interpreted log record(s) 312B (also shown in FIG. 3B).

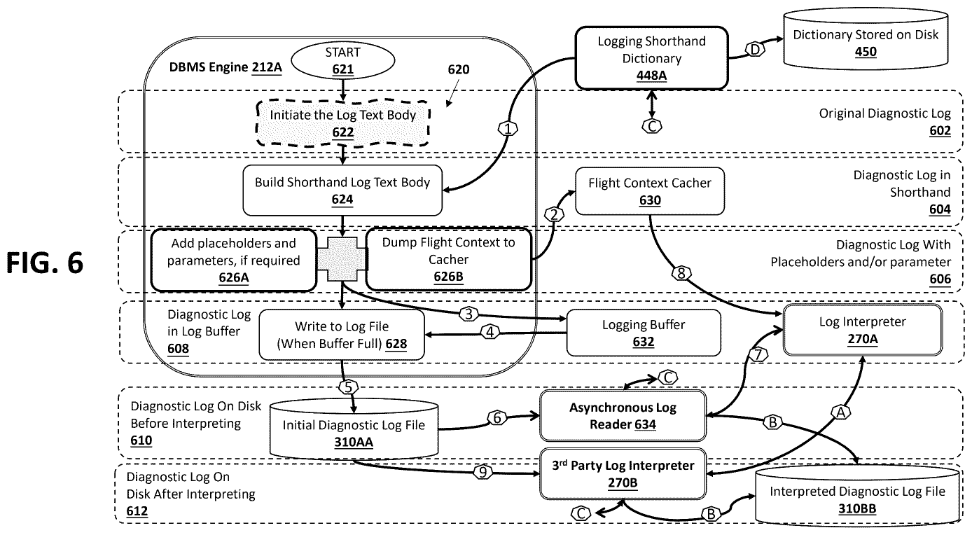

FIG. 6 depicts a simplified block diagram illustrating a non-limiting example of a DBMS engine 212A having incorporated therewith a diagnostic logging system configured to implement embodiments of the invention. The diagnostic logging system and the DBMS engine 212A are configured to, in accordance with embodiments of the invention, generate initial diagnostic log file 310AA, and subsequently generate interpreted diagnostic log file 310BB by interpreting or analyzing log records in the initial diagnostic log file 310AA. The initial diagnostic log file 310AA corresponds to and is substantially the same as the initial diagnostic log file 310A shown in FIG. 3A. The interpreted diagnostic log file 310BB corresponds to and is substantially the same as the interpreted diagnostic log file 310B shown in FIG. 3B. The functionality of the diagnostic logging system shown in FIG. 6 corresponds to the functionality of the diagnostic logging system 230 shown in FIG. 2 and the method 430 shown in FIG. 4. The diagnostic logging system shown in FIG. 6 is implemented by a method 620 performed by the DBMS engine 212A, along with operations performed by a logging shorthand dictionary 448A, a flight context cacher 630, a logging buffer 632, an asynchronous log reader 634, a log interpreter 270A, and a 3^{rd} party log interpreter 270B, configured and arranged as shown. The DBMS engine 212A and the diagnostic logging system are configured to, in accordance with embodiments of the invention, generate initial diagnostic log file 310AA and interpreted diagnostic log file 310BB. The DBMS engine 212A and the diagnostic logging system shown in FIG. 6 are organized around architectural/operational layers represented by an “Original Diagnostic Log” layer 602, a “Diagnostic Log in Shorthand” layer 604, a “Diagnostic Log with Placeholders and/or Parameters” layer 606 (where the placeholders/parameters correspond to the Pointer Information shown in FIG. 3A), a “Diagnostic Log in Log Buffer” layer 608, a “Diagnostic Log On Disk Before Interpreting” layer 610, and a “Diagnostic Log On Disk After Interpreting” layer 612. The architectural/organizational layers 602, 604, 606, 608, 610, 612 overlap with the portions of the DBMS engine 212A and the diagnostic logging system shown in FIG. 6 that perform operations of its associated architectural/organizational layer 602, 604, 606, 608, 610, 612.

Referring now to the components that are part of the diagnostic logging system shown in FIG. 6, the functionality of the logging shorthand dictionary 448A corresponds to the functionality of the shorthand dictionary 448 shown in FIG. 4. The flight context cacher 630 is configured to serve as the in-memory repository of all metadata and environmental states associated with a particular “flight” (i.e., a logical logging session or transaction). When a new flight starts, the flight context cacher initializes by retrieving or assembling its context (e.g., user credentials, session parameters, correlation identifiers, configuration settings, and resource handles) and stores this bundle under a unique flight key. As individual log events are emitted during the flight, the logging subsystem (e.g., logging subsystem 240 shown in FIG. 2) of the diagnostic logging system queries the flight context cacher 630 to efficiently associate the correct context to each record without incurring repeated I/O or re-computation. The flight context cacher 630 also monitors context freshness in that it refreshes entries if upstream configuration changes occur, and it evicts contexts once the flight completes or when a configured time-to-live (TTL) expires. Behind the scenes, the flight context cacher 630 maintains statistics on cache hits and misses to guide tuning (e.g., adjusting TTLs or pre-warming frequently reused contexts), and it exposes hooks for the diagnostic analyzer (e.g., the diagnostic analyzer 260 shown in FIG. 2) of the diagnostic logging system to correlate aggregated events back to their original flight contexts, thereby ensuring rapid, resource-efficient context propagation throughout end-to-end diagnostic workflows. The log interpreter 270A performs substantially the same functions as the log interpreter 270 shown in FIG. 2 with some of its log interpretations operations configured for the DBMS engine 212A and the diagnostic logging system shown in FIG. 6. The 3^{rd} party log interpreter 270B performs substantially the same functions as the log interpreter 270A with some of its log interpretations operations configured to enable remote access to the DBMS engine 212A and the diagnostic logging system shown in FIG. 6.

The logging buffer 632 can be implemented as a fixed-size, in-memory (or on-disk) circular storage that temporarily holds incoming log event information to decouple high-frequency event generation from slower I/O operations. As each set of log entry information is generated, it is appended to the logging buffer 632, which evicts the oldest entries once the buffer capacity is reached, thereby ensuring that only the most recent N records (where N=a whole number) are retained before flush. Sets of log entry information are then written out in batches to improve throughput and reduce the overhead of per-event disk writes. The batches can be output on a timed interval, when the buffer fills, or upon specific triggers like exceptions. The logging buffer 632 can be configured to maintain metadata pointers (e.g., head, tail, last-flushed) so that, in cases of log forwarding to remote systems, it can resume transmission from the correct offset after interruptions, thereby avoiding gaps or duplicates. In some embodiments, the logging buffer 632 can be scoped per transaction or session (“flight”), thereby allowing the diagnostic logging system to dump a context-specific buffer on error for precise post-event analysis without flooding the primary logs.

The asynchronous log reader (or asynchronous logger) 634 can be configured as a background software operation that calls the log interpreter 270A to, in effect, asynchronously reverse the operations (e.g., blocks 624, 626A, 626B of the method 620 shown in FIG. 6) used to create the initial log records (e.g., initial log record 312A shown in FIG. 3A) of the initial diagnostic log file 310AA, thereby creating the corresponding interpreted log records (e.g., interpreted log records 312B shown in FIG. 3B) of the interpreted diagnostic log file 310BB.

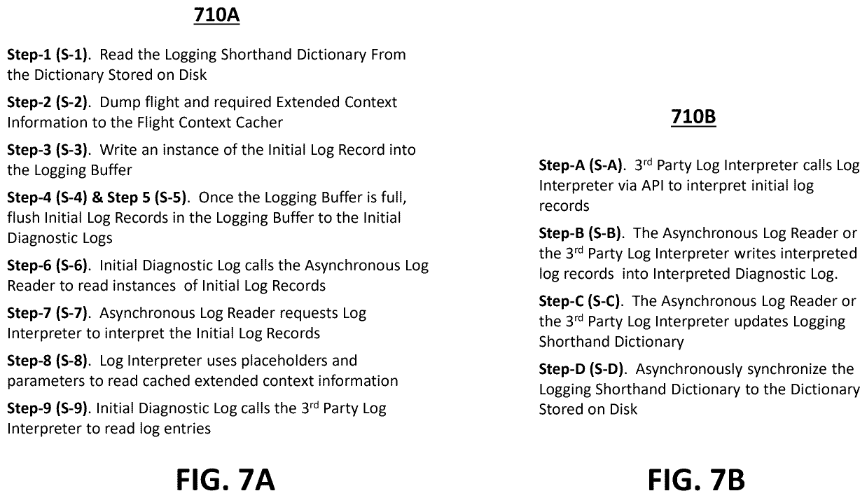

The operations performed by the DBMS engine 212A and the diagnostic logging system shown in FIG. 6 will now be described with reference to the method 620, a method 710A shown in FIG. 7A, and a method 710B shown in FIG. 7B. FIG. 7A depicts a process flow illustrating a computer-implemented method 710A performed by the DBMS engine 212A and the diagnostic logging system shown in FIG. 6 in accordance with embodiments of the invention. Similarly, FIG. 7B depicts a process flow illustrating a computer-implemented method 710B performed by the DBMS engine 212A and the diagnostic logging system shown in FIG. 6 in accordance with embodiments of the invention. For ease of reference and explanation, the blocks of the method 620 are depicted in FIG. 6 as three-digit reference numbers (621, 622, 624, 626A, 626B, 628), the steps of the method 710A are depicted as circled numbers (1, 2, 3, 4, 5, 6, 7, 8, and 9) shown in FIG. 6, and the steps of the method 710B are depicted as circled capital letters (A, B, C, D) shown in FIG. 6.

The method 620 starts at block 621 then moves to block 622 where the log text body is initiated or created by, for example, monitoring 520 and capturing 522 operational data 512 to generate diagnostic log event payload 316A and/or non-extended context information 316B as shown in FIG. 5. At block 624, the method 620 builds a shorthand version of the log text body by performing Step-1 (S-1). In Step-1 (S-1), the log text body is compared to a logging shorthand dictionary 448A read from the dictionary stored on disk 450. The logging shorthand dictionary can be built by applying a lossless compression technique (e.g., the method 1210 shown in FIG. 12) to multiple iterations of the monitoring 520 and capturing 522 operations to generate frequency-based and length-based encodings of the diagnostic log event payload 316A and the non-extended context information 316B. The shorthand version of the log text body can be generated by finding the associated encoding of the log text body in the logging shorthand dictionary 448A. In some embodiments of the invention, the shorthand version of the log text body can be generated by applying a lossless compression technique directly to the log text body.

The method 620 performs the operation at block 626A substantially concurrently with the operations at block 626B. At block 626A, placeholders and parameters are added to the shorthand version of the log text body, if required. The placeholders and parameters correspond to the Pointer Information (e.g., Pointer-A) of the initial diagnostic log file 310A shown in FIG. 3A in that the placeholders and parameters have significantly smaller data size than extended context information 316C that the placeholders and parameters represent. Additionally, like the Pointer Information, the placeholders and parameters link a particular shorthand version of the text body (e.g., the compressed log text 532 shown in FIG. 5) to its corresponding extended context information (e.g., extended context information 316C shown in FIG. 5) that will be stored in a memory (e.g., memory 322 shown in FIG. 5). At block 626B, Step-2 (S-2) is performed. In Step-2 (S-2), block 626B dumps flight and required context information (e.g., the extended context information 316C) to the flight context cacher 630. After blocks 626A and 626B, the placeholders/parameters (if any) have been added to the shorthand version of the text body to create an instance of an initial log record (e.g., initial log record 312A shown in FIG. 3A). In Step-3 (S-3), the instance of the initial log record is written into the Logging Buffer 632. When the logging buffer 632 is full, Step-4 (S-4) and Step 5 (S-5) are performed. In Step-4 (S-4) & Step 5 (S-5), once the Logging Buffer 632 is full, instances of the initial log record are flushed to the initial diagnostic log file 310AA.

At this stage, initial log records (e.g., initial log records 312A shown in FIG. 3A) are stored in the initial diagnostic log file 310AA. When it is necessary to review the initial diagnostic log file 310AA, the initial log records in the initial diagnostic log file 310AA need to be converted to a form that can understood and analyzed by a subject matter expert and/or an automated analysis tool (e.g., an automated analysis tool that include natural language processing (NLP)). In Step-6 (S-6), the initial diagnostic log file 310AA receives an inquiry or a request and, in response thereto, calls the asynchronous log reader 634, which performs Step-7 (S-7) and Step-C (S-C). In Step-7 (S-7), the asynchronous log reader 634 calls the log interpreter 270A and provides the log interpreter 270A with the placeholder/parameter information required in order to locate and access the associated extended context information in the flight context cacher 630. In Step-8 (S-8), the log interpreter 270A locates and reads the appropriate cached extended context information (e.g., extended context information 316C) from the flight context cacher 630. Also as part of Step-7 (S-7), the log interpreter 270A forwards the retrieved extended context information to the asynchronous log reader 634. The asynchronous log reader 634, through an instance of Step-C (S-C), uses the logging shorthand dictionary 448A to translate or decode the shorthand log text body to the log text body generated at block 622 and provide the decoded shorthand log text to the asynchronous log reader 634. The asynchronous log reader 634 uses the decoded log text body and the retrieved extended context information to build an interpreted log record (e.g., the interpreted log record 312B shown in FIG. 5) and provides the same, through one instance of Step-B (S-B), to the interpreted diagnostic log file 310BB. In Step-D (S-D), the logging shorthand dictionary 448A is synchronized to the dictionary stored on disk 450.

In some embodiments, the asynchronous log reader 634 is substantially co-located with the DBMS engine 212A and the diagnostic logging system shown in FIG. 6, and the 3^{rd} party log interpreter 270B can be remotely located from the DBMS engine 212A and the diagnostic logging system shown in FIG. 6. A computer component that is substantially co-located with a system can be implemented as a computer-on-system board that mount directly onto a carrier or baseboard within the same rack or chassis, sharing high-speed backplane interconnects and on-board power delivery for minimal latency and maximum throughput. Standards like COM-HPC (computer-on-module high performance computing) define modular embedded server architectures where processor, memory, and I/O reside immediately adjacent to the host infrastructure, enabling real-time processing of data at the network edge without the delays of long-haul transmission. By contrast, a remotely located computer components live in colocation data centers or cloud platforms, where compute nodes and storage are accessed over WAN (wide area network) or Internet links. Remotely located computer components decouple physical infrastructure from the application owner but introduces added latency and potential bandwidth constraints. A cloud-based computer component delivers elastic scaling and geographic distribution, but the tradeoff is real-time responsiveness for flexibility, cost-efficiency, and disaster-resilience that on-premise co-located setups cannot match. In practice, co-located computer components are chosen for latency-sensitive, high-bandwidth workloads (e.g., industrial control, telecom edge), whereas remotely hosted computer components align with globally distributed applications where scale and agility outweigh the need for sub-millisecond response times.

In embodiments of the invention, the 3^{rd} party log interpreter 270B performs, remotely, substantially the same interpretation operations as the substantially co-located asynchronous log reader 634 In Step-9 (S-9), the initial diagnostic log file 310AA receives an inquiry or a request and, in response thereto, calls the 3^{rd} party log interpreter 270B, which performs Step-A (S-A) and Step-C (S-C). In Step-A (S-A), the 3^{rd} party log interpreter 270B calls the log interpreter 270A and provides the log interpreter 270A with the placeholder/parameter information required in order to locate and access the associated extended context information in the flight context cacher 630. In Step-8 (S-8), the log interpreter 270A locates and reads the appropriate cached extended context information (e.g., extended context information 316C) from the flight context cacher 630. Also as part of Step-A (S-A), the log interpreter 270A forwards the retrieved extended context information to the 3^{rd} party log interpreter 270B. The 3^{rd} party log interpreter 270B, through an instance of Step-C (S-C), uses the logging shorthand dictionary 448A to translate or decode the shorthand log text body to the log text body generated at block 622 and provide the decoded shorthand log text to the 3^{rd} party log interpreter 270B. The 3^{rd} party log interpreter 270B uses the decoded log text body and the retrieved extended context information to build an interpreted log record (e.g., the interpreted log record 312B shown in FIG. 5) and provides the same, through another instance of Step-B (S-B), to the interpreted diagnostic log file 310BB. In Step-D (S-D), the logging shorthand dictionary 448A is synchronized to the dictionary stored on disk 450. In some embodiments of the invention, the asynchronous log reader 634 and/or the 3^{rd} party log interpreter 270B can be configured to enable additional information related to the post-event analysis, the root-cause analysis and the like to be added to the interpreted log record (e.g., interpreted log record 312B shown in FIG. 3B) stored in the interpreted diagnostic log file 310BB.

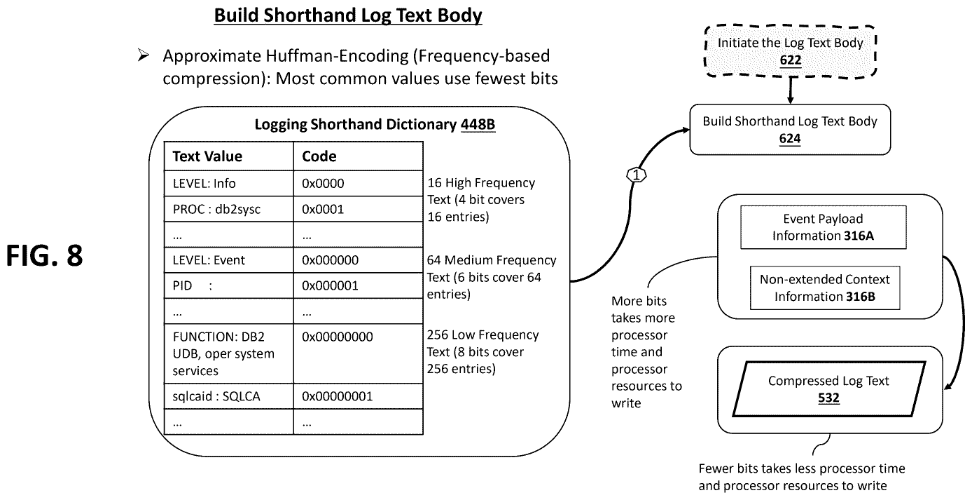

FIG. 8 depicts a simplified block diagram illustrating additional details of how the Shorthand Log Text Body built at block 624 of the method 620 can be built in accordance with embodiments of the invention. A non-limiting example of a logging shorthand dictionary 448B is depicted in FIG. 8. The logging shorthand dictionary 448 is a non-limiting example of how the logging shorthand dictionary 448A (shown in FIG. 6) can be implemented in accordance with aspects of the invention. The logging shorthand dictionary 448B can be a table having Text Value columns and a corresponding Code columns. The information in the Text Value columns includes diagnostic log event payload 316A and non-extended context information 316B. The information in the Code columns includes compressed log text 532. As reflected in FIG. 8, Text Value (e.g., diagnostic log event payload 316A with non-extended context information 316B) is represented with more bits than Code information (e.g., compressed log text 532. More bits takes more processor time and processor resources to write, and fewer bits takes less processor time and processor resources to write. An approximate Huffman-encoding algorithm (e.g., as shown in FIG. 12) is used to generate its shortest length (e.g., 4 bits) encoding (i.e., the Code column) string for Text Values that occur with high frequences (e.g., 16 instances). A medium length (e.g., 6 bits) encoding string is provided for Text Values that occur with medium frequency (e.g., 64 instances). A longer length (e.g., 8 bits) encoding string is provided for Text Values that occur with low frequency (e.g., 256 instances). The approximate Huffman-encoding algorithm (e.g., as shown in FIG. 12) used in embodiments of the invention improves compression rates, thereby reducing resource consumption during log writing and transmission, as well as saving disk space for log storage. This approach is effective because the approximate Huffman-encoding algorithm encodes more frequently repeated strings with fewer bits, and log data, by nature, tends to contain many repetitive string patterns.

When the DBMS engine 212A and the diagnostic logging system (both shown in FIG. 6) have been operating for several days, many log messages will be written over the course of that time. The log message can be organized into a number of small pieces of strings. The encoding algorithm (e.g., method 1210 shown in FIG. 12) can compute the number of times each of the streams appears totally in the log messages, and then order the strings based on the number of times the string appears. With that information, the occurrence frequency for each of the streams. For example, it can be determined that String A appears one-thousand (1000) times and has the highest appearance frequency. This can be labeled as the “high frequency” category as shown in FIG. 8. In this category, there are sixteen (16) streams, and 4 bits will be used to cover all of the 16 entries. Another stream can be labeled as a “medium frequency” category. For example, it can be determined that String B appears five hundred (500) times and has the next highest appearance frequency. In this category there are sixty-four (64) streams, and 6 bits will be used to cover all of the 64 entries. Another stream can be labeled as a “low frequency” category. For example, it can be determined that String C appears fifty (50) times and has the next highest appearance frequency. In this category there are two hundred and fifty six (256) streams/entries, and 8 bits will be used to cover all of the 256 streams/entries. By this method, the logging shorthand dictionary 448 can be built and used at block 624 of the method 620 (shown in FIG. 6) to build the shorthand log text body.

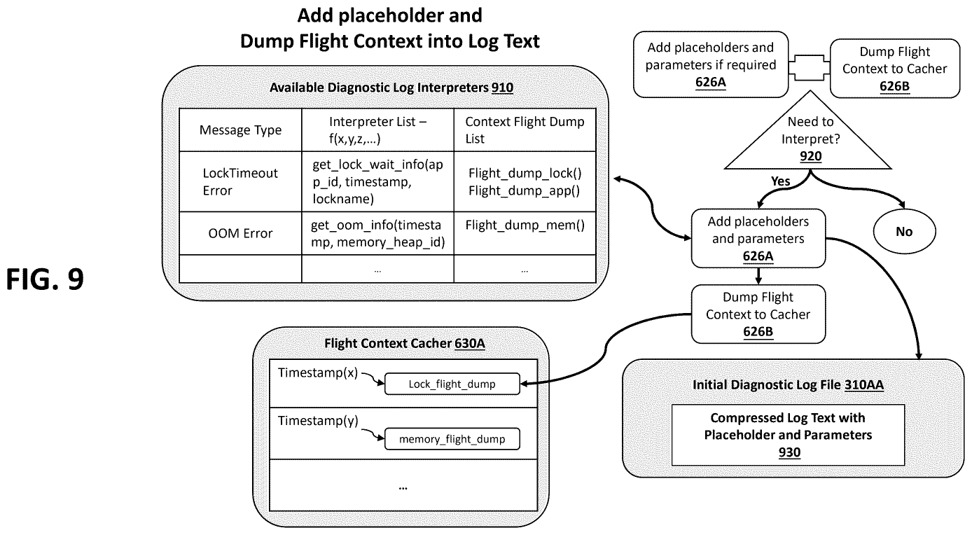

FIG. 9 depicts a simplified block diagram illustrating additional details of how placeholder information can be added, along with how flight context information is dumped into the log text. The diagnostic logging system and the DBMS engine 212A (shown in FIG. 6) maintain a dictionary called available diagnostic log interpreters 910, which is indexed by “Message Type” (indicating the log message type). The available diagnostic log interpreters 910 include two fields, namely an Interpreter List and a Context Flight Dump List. The Interpreter List includes the method names and parameters needed to extend context information for such log messages. The Context Flight Dump List includes the method names used to dump extended context information of such logs into memory (e.g., cache memory).

During the processing of a log entry, the diagnostic logging system and the DBMS engine 212A (shown in FIG. 6) determine at decision block 920 whether the log entry requires interpretation by checking if the log's message type exists in the Available Diagnostic Log Interpreters 910, which can be implemented in the form of a dictionary. If present, the diagnostic logging system can extend the log entry with extended context information. In some embodiments of the invention, this context enrichment is implemented by the diagnostic logging system using the Message Type index to locate the corresponding Interpreter List index, which specifies the method names and parameter lists (e.g., current timestamp, application unique ID) required to extend the contextual information.

The diagnostic logging system then writes this information into the log record as a placeholder (e.g., compressed log text with placeholder and parameters 930 of the initial diagnostic log file 310AA), which is shown at block 626A. For example, a “LockTimeout Error” log would generate a placeholder such as “<PH get_lock_wait_info(‘0-25’, 1686477073, 0x50003002100000052)/PH>,” here ‘0-25’ is the Application unique ID; 1686477073 is the Timestamp of the error occurrence; and 0x50003002100000052 is the name of the lock that timed out.

Substantially concurrently with the above, the diagnostic logging system retrieves the corresponding “Context Flight Dump List” (e.g., Flight_dump_lock() and Flight_dump_app()) based on the “Message Type.” The diagnostic logging system invokes these methods to, at block 626B, dump the extended contextual information into a cache system, which is the memory buffer named flight context cacher 630A. Flight context cacher 630A is a non-limiting example implementation of the flight context cacher 630 (shown in FIG. 6). The contextual information cached in the memory is indexed by the timestamp when dumping happens. The mechanism depicted in FIG. 9 ensures that logs remain concise while enabling dynamic extending and contextual diagnostics through placeholders and memory-stored details.

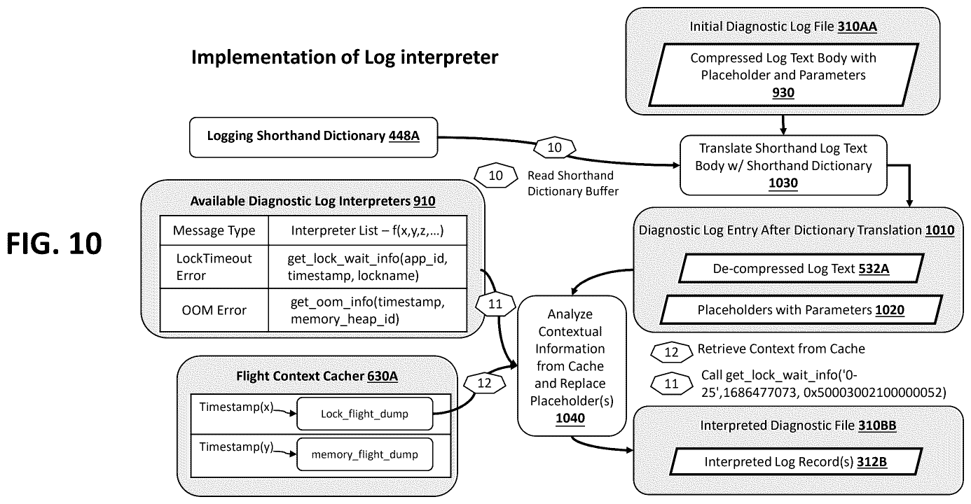

FIG. 10 depicts a simplified block diagram illustrating additional details of how the log interpreter shown 270A (shown in FIG. 6) can be implemented in accordance with embodiments of the invention, using Step-10 (S-10), Step-11 (S-11), and Step-12 (S-12). Step-10 (S-10), Step-11 (S-11), and Step-12 (S-12) are each depicted in FIG. 10 as circled numbers (10, 11, and 12). The log interpreting process depicted in FIG. 10 includes three steps, namely, shorthand translation (S-10), placeholder processing (S-11), and context retrieval and replacement (S-12). In shorthand translation (S-10), at block 1030, the diagnostic logging system translates the shorthanded log text body using the logging shorthand dictionary 448B (as shown in FIG. 8). For each code in the logging shorthand dictionary 448B, the diagnostic logging system looks up the corresponding “Text Value” in the logging shorthand dictionary 448B and replaces the Code with its associated Text Value. For example, 0x0000 would be replaced with “LEVEL: Info.” In placeholder processing (S-11), when the diagnostic logging system detects a placeholder in the log record (which contains both a method name for retrieving contextual information, along with its parameter list), the diagnostic logging system directly invokes the corresponding method associated with the placeholder. These methods are pre-implemented in the system and registered in the available diagnostic log interpreters 910 (shown in FIG. 9 and in FIG. 10). In context retrieval and replacement (S-12), at block 1040, the invoked method uses the provided parameter list to retrieve the corresponding raw contextual information from the flight context cacher 630 (shown in FIG. 6); perform necessary analysis to generate human-readable extended context information; and replace the placeholder context with this processed information, thereby forming the interpreted log record 312B, which can be stored in the interpreted diagnostic log file 310BB. Thus, (S-10), (S-11), and (S-12) access the initial diagnostic log file 310AA that contains compressed log text body with placeholder and parameters 930; generate therefrom a diagnostic log entry after dictionary translation 1010 that includes decompressed log text 532A and placeholders with parameters 1020; further generate therefrom the interpreted log record 312B; and store the interpreted log record 312B in the interpreted diagnostic log file 310BB.

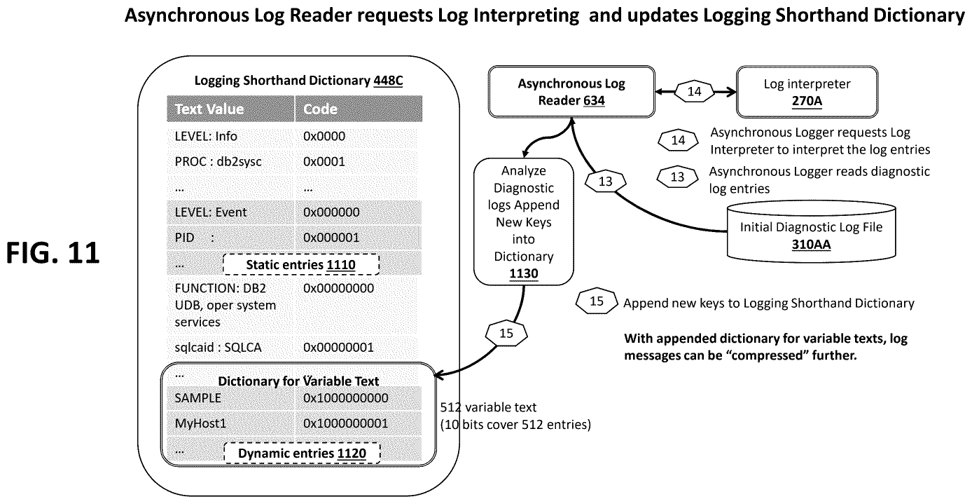

FIG. 11 depicts a simplified block diagram illustrating additional details of how the asynchronous log reader 634 requests interpretation services from the log interpreter 270A and updates a logging shorthand dictionary 448C. The logging shorthand dictionary 448C is substantially the same as the logging shorthand dictionary 448B (shown in FIG. 8) except the logging shorthand dictionary 448C is configured to organized its entries around static entries 1110 and dynamic entries 1120. The interpretation-related operations depicted in FIG. 11 use Step-13 (S-13), Step-14 (S-14), and Step-15 (S-15), which are each represented in FIG. 11 as circled numbers (13, 14, and 15). As iterations of the operations performed by the DBMS engine 212A (shown in FIG. 6) proceed, users can create new databases or tables, or drop existing objects, causing object names in log messages to change. If solely a static shorthand dictionary is used, the log compression ratio would degrade over time. To address this, the diagnostic logging system maintains the logging shorthand dictionary 448C divided into two parts, namely, static entries 1110 and dynamic entries 1120. Static entries 1110 include predefined entries that remain substantially unchanged once generated. Dynamic entries 1120 (labeled as “Dictionary for Variable Text” in FIG. 11) periodically update entries to adapt to runtime changes. FIG. 11 illustrates the periodic update process for dynamic entries 1120. At Step-13 (S-13), the asynchronous log reader 634 reads from the initial diagnostic log file 310AA initial log records (e.g., compressed log text body with placeholders and parameters 930 shown in FIGS. 9 and 10) generated during the latest cycle (cycle length is configurable via parameters). At Step-14 (S-14), the asynchronous log reader 634 invokes the log interpreter 270A (using the “implementation of log interpreter” processes shown in FIG. 10) to interpret the initial log records collected in Step-13 (S-13). At block 1130 and Step-15 (S-15), the interpreted log records are broken down into keywords, and each keyword's frequency is counted and sorted in descending order. Keywords already present in the static entries 1110 are ignored. The top remaining keywords are assigned. In the non-limiting example, five hundred and twelve (512) remaining keywords are assigned with five hundred and twelve (512) different codes with length of ten (10) bits and replace the current dynamic entries 1120. This dynamic update mechanism ensures optimal log compression efficiency while adapting to runtime schema changes.

FIG. 12 depicts a flow diagram illustrating a method 1210 in accordance with embodiments of the invention. The method 1210 is a non-limiting example of how an approximate Huffman-encoding algorithm can be implemented. As previously-described herein, the log record compression functionality 242 (shown in FIG. 2) and/or the shorthand technique 242A (shown in FIG. 4) can be implemented using an approximate Huffman-encoding algorithm. Approximate Huffman-encoding algorithms trade perfect compression efficiency for faster processing, lower memory use, and simpler implementation. Such algorithms are particularly useful in systems with limited processor resources (e.g., real-time systems) or where speed is more important than minimal file size. By using sampling, binning, and heuristics, approximate Huffman-encoding algorithms avoid the overhead of exact tree construction while still maintaining most of the benefits of Huffman coding.

The method 1210 begins at block 1212 where input data is gathered. The input data is the raw data stream that is to be compressed. The input data typically includes a sequence of symbols (characters, bytes, or other data units). In many real-world applications, the input data can include a file, a network packet, or live sensor data. In traditional Huffman coding, the entire input data is analyzed to calculate the exact frequency of each symbol. In the approximate version, especially when dealing with large-scale or streaming data, the input data can be processed in chunks or samples. Block 1212 acts as the data source for the method 1210.

At block 1214 of the method 1210, frequency estimation operations are performed. Instead of performing a full frequency analysis, which can be computationally intensive and time consuming, the approximate Huffman-encoding approach uses techniques such as sampling, probabilistic counting, or sketching algorithms (e.g., Count-Min Sketch) to estimate the frequency of each symbol. Using estimation helps reduce the overall computational load by not requiring an exact count. The trade-off is that while the frequency estimates are close enough to be useful, they may not be perfectly accurate. Block 1214 is particularly useful where data volume is large or when real-time processing is required.

At block 1216 of the method 1210, the frequency estimates generated at block 1214 are compiled into a frequency table configured to list each unique symbol along with its estimated frequency. A cleanup or normalization is applied to the table where extremely low-frequency symbols can be grouped or discarded based on heuristic thresholds to simplify the subsequent tree construction. The cleanup or normalization operations are also referred to as symbol binning or grouping where symbols with similar or low frequencies can be binned together. This “grouping” reduces the effective alphabet size by merging symbols that occur very infrequently or that are statistically similar. This binning step is beneficial in reducing the number of distinct entries and simplifies the later stages of code generation. Often, such grouping can be realized by mapping multiple low-frequency symbols onto a single representative “bin” and then handling those collectively in the code assignment phase. The cleanup, normalization, binning, or grouping process ensures that the resulting table is well-formed and optimized for rapid tree generation.

At block 1218 of the method 1210, approximate Huffman tree construction is performed. In traditional Huffman encoding, nodes are merged strictly based on the exact frequencies to build an optimal binary tree. In approximate Huffman-encoding, a tree is built using greedy heuristics that can allow for slight deviations from the optimal merging order. Techniques such as threshold-based merges or batch processing of low-frequency nodes can be applied to speed up the tree construction. The result of the operations at block 1218 is a binary tree that represents an approximate (but fast-to-compute) structure for assigning prefix codes. As previously noted, the method 1210, which represents an example approximate Huffman-encoding algorithm, prioritizes speed and reduced computational overhead over absolute optimality in the compression ratio.

At block 1220 of the method 1210, subsequent to construction of the approximate Huffman tree, prefix codes (e.g., binary strings) are derived for each symbol by traversing the tree. Each symbol is assigned a code that is guaranteed to be prefix-free (no code is a prefix of another), which is essential for uniquely decodable compression. The code assignment operations performed at block 1220 can also include additional steps such as pruning or adjusting the codes to account for any rough edges introduced during the approximate counting and tree construction phases, thereby ensuring that the final codes are robust for encoding.

At block 1222 of the method 1210, the derived prefix codes are used to encode the original input data provided at block 1212. The input symbols are replaced by their corresponding codewords to produce at block 1224 a compressed output stream of encoded output data. The compressed output stream can be accompanied by a minimal header or metadata that provides just enough information for a decoder to reconstruct the symbol-to-code mapping, often pre-shared or determinable by an identical heuristic procedure. Although the compression achieved with an approximate Huffman-encoding algorithm can under some circumstances be slightly less efficient than that of the full version of Huffman coding, approximate Huffman-encoding provides a significant speed advantage and reduced computing resource usage, thereby making it suitable for real-time and resource-constrained applications.

The approximate Huffman-encoding algorithm represented by the method 1210 qualifies as a lossless compression technique because, despite using heuristic methods for efficiency, it still provides an exact, reversible mapping from the input symbols (or symbol groups) to binary codewords. In a lossless compression method, every bit of the original data must be recoverable without error during decompression. Even though the approximate Huffman algorithm can use approximate strategies, such as sampling for frequency estimation and grouping symbols with similar frequencies to simplify code length assignment, the final output at block 1224 includes a unique, prefix-free binary code for each processed unit regardless of whether the processed unit is individual symbols or groups of symbols. This unique assignment ensures that the decoder, using the agreed-upon mapping or the information transmitted along with the compressed data, can accurately reproduce the entire original data set exactly as it was before compression. The approximations serve solely to enhance computational efficiency and reduce processing time. However, the approximation do not sacrifice the one-to-one correspondence required for perfect reconstruction, thereby maintaining the lossless nature of the compression process in an approximate Huffman-encoding algorithm.

Thus, it can be seen from the foregoing detailed description that embodiments of the invention address the previously-described and other challenges with writing relatively large amounts of data into diagnostic log file records by providing computing systems, computer-implemented methods, and/or computer program products that utilize selective encoding and cache memory storage techniques to capture a relatively large amount (or volume) of data/information (e.g., non-extended and/or extended context information) as encoded portions and memory-stored portions of the relatively large amount of data/information. The processor time and computing resources that are required in order to write the encoded portions to a diagnostic log file and store the memory-stored portions to a memory (e.g., cache memory) are significantly less than the processor time and computing resources requires to write the unencoded version of the encoded portions of the relatively large amount of data/information, as well as the memory-stored portions of the relatively large amount of data/information directly into a diagnostic log record. The approximate Huffman-encoding algorithm as represented by the method 1210 (shown in FIG. 12) used in embodiments of the invention improves compression rates, thereby reducing resource consumption during log writing and transmission, as well as saving disk space for log storage. This approach is effective because the approximate Huffman-encoding algorithm encodes more frequently repeated strings with fewer bits, and log data, by nature, tends to contain many repetitive string patterns.

For the sake of brevity, conventional techniques related to making and using aspects of the invention may or may not be described in detail herein. In particular, various aspects of computing systems and specific computer programs to implement the various technical features described herein are well known. Additionally, conventional techniques related to semiconductor device and IC design and fabrication may or may not be described in detail herein. Moreover, the various tasks and process steps described herein can be incorporated into a more comprehensive procedure or process having additional steps or functionality not described in detail herein. Thus, in the interest of brevity, many conventional implementation details are only mentioned briefly herein or are omitted entirely without providing the well-known system and/or process details.

Many of the functional units of the systems described in this specification have been labeled as modules. Embodiments of the invention apply to a wide variety of module implementations. For example, a module can be implemented as a hardware circuit including custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like. Modules can also be implemented in software for execution by various types of processors. An identified module of executable code can, for instance, include one or more physical or logical blocks of computer instructions which can, for instance, be organized as an object, procedure, or function. Nevertheless, the executables of an identified module need not be physically located together but can include disparate instructions stored in different locations which, when joined logically together, function as the module and achieve the stated purpose for the module.

The components/modules of the systems illustrated herein are depicted separately for ease of illustration and explanation. In embodiments of the invention, the functions performed by the components/modules can be distributed differently than shown without departing from the scope of the various embodiments of the invention describe herein unless it is specifically stated otherwise.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The terms “raw data” and variations thereof are used herein to refer to the unprocessed, original information collected directly from an electronic system without any transformation, interpretation, or filtering. Raw data is characterized by its fidelity to the initial measurement or observation, which includes every nuance, noise, and detail as generated by the source (e.g., a sensor system). Unlike processed or aggregated data, raw data has not been cleansed or normalized, which means that it can contain redundancies, irrelevant details, and potentially extraneous metadata. The abundance and unstructured nature of raw data may require further processing to make it digestible and actionable, which distinguishes raw data from other data forms that have been refined and formatted for specific analytical or operational uses.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It will be understood that those skilled in the art, both now and in the future, may make various improvements and enhancements which fall within the scope of the claims which follow.

What is claimed is:

1. A computer-implemented method comprising:
detecting an event by electronically monitoring and capturing, using a processor system, operational data associated with operations performed by subcomponents within an electronic system, wherein the operations are separated from one another by sub-millisecond time gaps;
responsive to detecting the event, generating, using the processor system, an event record;
further responsive to detecting the event, using the processor system to, based at least in part on a type of the event, generate context information associated with the event;
storing the context information in a memory location instead of inserting the context information into the event record;
applying a shorthand technique to one or more segments of the event record to generate a shorthand version of the event record; and
writing the shorthand version of the event record in an initial diagnostic log file.

2. The computer-implemented method of claim 1 further comprising:
generating, using the processor system, pointer information that associates the shorthand version of the event record with the memory location that stores the context information; and
associating the pointer information with the shorthand version of the event record.

3. The computer-implemented method of claim 2 further comprising performing a post-event troubleshooting process comprising reversing the shorthand technique applied to the shorthand version of the event record to generate a reversed event record.

4. The computer-implemented method of claim 3, wherein the post-event troubleshooting process further comprises using the pointer information to retrieve the context information from the memory location.

5. The computer-implemented method of claim 4, wherein the post-event troubleshooting process further comprises forming an interpreted event record comprising:
the reversed event record; and
the context information retrieved from the memory location.

6. The computer-implemented method of claim 5, wherein:
the shorthand technique comprises a lossless compression technique;
the shorthand version of the event record comprises a compressed version of the event record; and
the pointer information is used to call a function that retrieves the context information from the memory location.

7. The computer-implemented method of claim 6, wherein:
the electronic system comprises a database having a database management system (DBMS);
the processor system is incorporated within the DBMS;
the memory location comprises a cache memory;
the type of the event comprises an error event;
the context information is stored in the cache memory asynchronously;
the compressed version of the event record is generated using a translation dictionary; and
the compressed version of the event record is written asynchronously in the initial diagnostic log file.

8. A computer system comprising a processor system electronically connected to a memory, wherein the processor system is operable to perform processor system operations comprising:
detecting an event by electronically monitoring and capturing operational data associated with operations performed by subcomponents within an electronic system, wherein the operations are separated from one another by sub-millisecond time gaps;
responsive to detecting the event, generating an event record;
further responsive to detecting the event, based at least in part on a type of the event, generating context information associated with the event;
storing the context information in a memory location instead of inserting the context information into the event record;
applying a shorthand technique to one or more segments of the event record to generate a shorthand version of the event record; and
writing the shorthand version of the event record in an initial diagnostic log file.

9. The computer system of claim 8, wherein the processor system operations further comprise:
generating pointer information that associates the shorthand version of the event record with the memory location that stores the context information; and
associating the pointer information with the shorthand version of the event record.

10. The computer system of claim 9, wherein the processor system operations further comprise performing a post-event troubleshooting process comprising reversing the shorthand technique applied to the shorthand version of the event record to generate a reversed event record.

11. The computer system of claim 10, wherein the post-event troubleshooting process further comprises using the pointer information to retrieve the context information from the memory location.

12. The computer system of claim 11, wherein the post-event troubleshooting process further comprises forming an interpreted event record comprising:
the reversed event record; and
the context information retrieved from the memory location.

13. The computer system of claim 12, wherein:
the shorthand technique comprises a lossless compression technique;
the shorthand version of the event record comprises a compressed version of the event record; and
the pointer information is used to call a function that retrieves the context information from the memory location.

14. The computer system of claim 13, wherein:
the electronic system comprises a database having a database management system (DBMS);
the processor system is incorporated within the DBMS;
the memory location comprises a cache memory;
the type of the event comprises an error event;
the context information is stored in the cache memory asynchronously;
the compressed version of the event record is generated using a translation dictionary; and
the compressed version of the event record is written asynchronously in the initial diagnostic log file.

15. A computer program product comprising a computer readable program stored on a computer readable storage medium, wherein the computer readable program, when executed on a processor system, causes the processor system to perform processor system operations comprising:
detecting an event by electronically monitoring and capturing operational data associated with operations performed by subcomponents within an electronic system, wherein the operations are separated from one another by sub-millisecond time gaps;
responsive to detecting the event, generating an event record;
further responsive to detecting the event, based at least in part on a type of the event, generating context information associated with the event;
storing the context information in a memory location instead of inserting the context information into the event record;
applying a shorthand technique to one or more segments of the event record to generate a shorthand version of the event record; and
writing the shorthand version of the event record in an initial diagnostic log file.

16. The computer program product of claim 15, wherein the processor system operations further comprise:
generating pointer information that associates the shorthand version of the event record with the memory location that stores the context information; and
associating the pointer information with the shorthand version of the event record.

17. The computer program product of claim 16, wherein the processor system operations further comprise performing a post-event troubleshooting process comprising reversing the shorthand technique applied to the shorthand version of the event record to generate a reversed event record.

18. The computer program product of claim 17, wherein the post-event troubleshooting process further comprises using the pointer information to retrieve the context information from the memory location.

19. The computer program product of claim 18, wherein the post-event troubleshooting process further comprises forming an interpreted event record comprising:
the reversed event record; and
the context information retrieved from the memory location.

20. The computer program product of claim 19, wherein:
the shorthand technique comprises a lossless compression technique;
the shorthand version of the event record comprises a compressed version of the event record;
the pointer information is used to call a function that retrieves the context information from the memory location;
the electronic system comprises a database having a database management system (DBMS);
the processor system is incorporated within the DBMS;
the memory location comprises a cache memory;
the type of the event comprises an error event;
the context information is stored in the cache memory asynchronously;
the compressed version of the event record is generated using a translation dictionary; and
the compressed version of the event record is written asynchronously in the initial diagnostic log file.
